(19) United States
(12) Patent Application Publication
(10) Pub. No.: US 2016/0121487 A1
(43) Pub. Date: May 5, 2016

(54) Communicating Configurable Instruction Sets to Robots for Controlling Robot Behavior

(71) Applicant: QUALCOMM Incorporated, San Diego, CA (US)

(72) Inventors: Siddharth Mohan, San Diego, CA (US); Snehesh Shrestha, Danbury, CT (US); Ashwin Vijayakumar, San Diego, CA (US)

(21) Appl. No.: 14/531,441

(22) Filed: Nov. 3, 2014

(51) Int. Cl. B25J 13/00; B25J 13/08; B25J 9/00

(52) U.S. Cl. CPC B25J 13/006; B25J 9/0084; B25J 13/08; B25J 13/085

(57) ABSTRACT

Methods, devices, systems, and non-transitory process-readable storage media for guiding behaviors of robots within a deployment site by communicating updated instruction sets through beacon devices or other proximity mechanisms. In an embodiment, a processor of a beacon device may perform operations including presenting (e.g., broadcasting, rendering, etc.) an instruction set to a first robot, receiving an instruction set update from the first robot, modifying the stored instruction set with the update, and presenting the modified instruction set to a second robot. Similarly, a robot may be configured with instructions for executing a stored instruction set to cause the robot to perform various actions, generating the instruction set update in response to performing the actions based on an execution of the stored instruction set, and presenting the instruction set update to the beacon device. Robots may also be configured to configure and deploy beacon devices.

### BACKGROUND

Conventional programmable robots (or drones) may be programmed with instruction sets to perform various tasks, such as traverse various environments (e.g., buildings, exterior locations, etc.) and/or conduct operations to fulfill a task (e.g., mapping terrain, etc.). Conventional methods for programming such robots to perform tasks may include the use of barcodes, such as barcodes providing an address for uploading instruction for manufacturing items by multi-purpose robots in a manufacturing plant. The complexity of programming and/or operations for robots to execute can increase with the length of the task. In particular, a robot dispatched on a mission requiring the robot to move some distance (e.g., away from a central hub or server) may utilize programming having a very long set of instructions and information to handle various navigational requirements and environmental conditions when performing its mission. For example, when tasked with a mission to map a labyrinth (e.g., map with imaging sensors, etc.), a robot may require instructions and information to be processed at several different points in order to decide on the next steps for moving around the labyrinth (e.g., which room to enter, whether to go up or down to a different floor, etc.). Such decision-making instructions and information may require significant memory storage as well as complex pre-established programming (e.g., algorithms that can handle various scenarios and conditions). Configuring robots in advance using conventional methods may not be feasible in many applications, and may not be able to anticipate and account for changes in the environment, such as obstacles.

### SUMMARY

Various embodiments provide methods, devices, systems, and non-transitory process-readable storage media for communicating configurable instruction sets to robots. An embodiment method may be performed by a processor of a beacon device and may include presenting a stored instruction set to a first robot, receiving an instruction set update from the first robot, modifying the stored instruction set based on the received instruction set update to generate a modified instruction set, and presenting the modified instruction set to a second robot. In some embodiments, the method may further include determining whether the instruction set update is valid, and modifying the stored instruction set based on the received instruction set update may include modifying the stored instruction set in response to determining that the instruction set update is valid. In some embodiments, determining whether the instruction set update is valid may include determining whether the instruction set update is capable of being executed by the robots, is authenticated, is related to a type of robot, can be compiled with regards to the stored instruction set, and is newer than a portion of the stored instruction set.

In some embodiments, modifying the stored instruction set based on the received instruction set update to generate a modified instruction set may include replacing the stored instruction set or a portion of the stored instruction set with the received instruction set update. In some embodiments, presenting the stored instruction set or the modified instruction set may include at least one of broadcasting data via wireless signaling, transmitting data via an established wireless connection, and rendering data on one of a display, a speaker, a light source, and a vibration motor. In some embodiments, presenting the stored instruction set or the modified instruction set may include rendering the data as a quick response (QR) code on a display. In some embodiments, receiving the instruction set update from the first robot may include at least one of receiving the instruction set update via wireless broadcasts from the first robot, receiving the instruction set update via an established wireless connection with the first robot, and receiving the instruction set update from the first robot using a sensor selected from the group of a camera, a microphone, a light sensor, and a vibration sensor.

In some embodiments, the stored instruction set may be one of a plurality of instruction sets stored on the beacon device, and each in the plurality of instruction sets stored on the beacon device may correspond to a different type of robot. In some embodiments, the method may further include determining whether wide area network connectivity is available, and exchanging data with a remote data source in response to determining wide area network connectivity is available.

An embodiment method for a robot to update instruction sets that are presented by a beacon device for use by other robots within proximity may be performed by a processor of the robot and may include executing a stored instruction set to cause the robot to perform actions, generating an instruction set update in response to performing the actions based on an execution of the stored instruction set, and presenting the instruction set update to the beacon device. In some embodiments, the method may further include receiving a new instruction set from the beacon device, modifying the stored instruction set based on the received new instruction set to generate a modified instruction set, and executing the modified instruction set.

In some embodiments, the method may further include determining whether the new instruction set is valid, and modifying the stored instruction set based on the received new instruction set may include modifying the stored instruction set in response to determining that the new instruction set is valid. In some embodiments, determining whether the new instruction set is valid may include determining one or more of whether the new instruction set is capable of being executed by the robot, is authenticated, is related to a type of robot corresponding to the robot, can be compiled with regards to the stored instruction set, and is newer than a portion of the stored instruction set. In some embodiments, modifying the stored instruction set based on the received new instruction set may include replacing the stored instruction set or a portion of the stored instruction set with the received new instruction set. In some embodiments, receiving the new instruction set from the beacon device may include at least one of receiving the new instruction set via wireless broadcasts from the beacon device, receiving the new instruction set via an established wireless connection with the beacon device, and receiving the new instruction set from the beacon device by scanning using a sensor selected from a group of a camera, a microphone, a light sensor, and a vibration sensor.

In some embodiments, the method may further include configuring a new beacon device to present the modified instruction set, and deploying the new beacon device. In some embodiments, deploying the new beacon device may include placing the new beacon device into a deployment site. In some embodiments, presenting the instruction set update to the beacon device may include at least one of broadcasting the instruction set update via wireless signaling, transmitting the instruction set update via an established wireless connection, and rendering the instruction set update on one of a display, a speaker, a light source, and a vibration motor.

Further embodiments include various computing devices (e.g., beacon devices, robots, etc.) configured with processor-executable instructions for performing operations of the methods described above. Further embodiments include non-transitory processor-readable media on which are stored processor-executable instructions configured to cause processors to perform operations of the methods described above. Further embodiments include a communication system including a beacon device and at least a robot configured with processor-executable instructions to perform operations of the methods described above.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a component block diagram of an exemplary communication system including robots and beacon devices according to various embodiments.

FIGS. 2A-2B are diagrams illustrating exemplary instruction sets provided by beacon devices according to various embodiments.

FIGS. 3A-3E are process flow diagrams illustrating embodiment methods for a beacon device to provide public instruction sets to and/or receive instruction set updates from robots within proximity.

FIGS. 4A-4F are process flow diagrams illustrating embodiment methods for a robot to receive instruction sets from and/or provide instruction set updates to beacon devices within proximity.

FIGS. 5A-5B are call flow diagrams illustrating various communications between beacon devices and robots within proximity according to various embodiments.

FIGS. 6A-6F are top views of a beacon device and robots near a deployment site that illustrate an exemplary scenario according to various embodiments.

FIG. 6G is a call flow illustrating embodiment communications and modifications of instruction sets of robots and a beacon device according to an exemplary scenario.

FIG. 7 is a component block diagram of an example beacon device suitable for use with the various embodiments.

FIG. 8 is a component block diagram of an example robot suitable for use with the various embodiments.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The term “robot” is used herein to refer to any programmable, autonomous (or unmanned) device capable of performing various actions. For the purposes of this disclosure, robots may include at least a processor for executing locally-stored programming. Such programming may be referred to herein as “instruction set(s)” and may include any number of actionable or executable data, such as programs, applications, task lists, routines, threads, instructions, commands, code, variables, directions (e.g., optimal path directions, etc.), and/or other information that may be used for controlling actions of a robot.

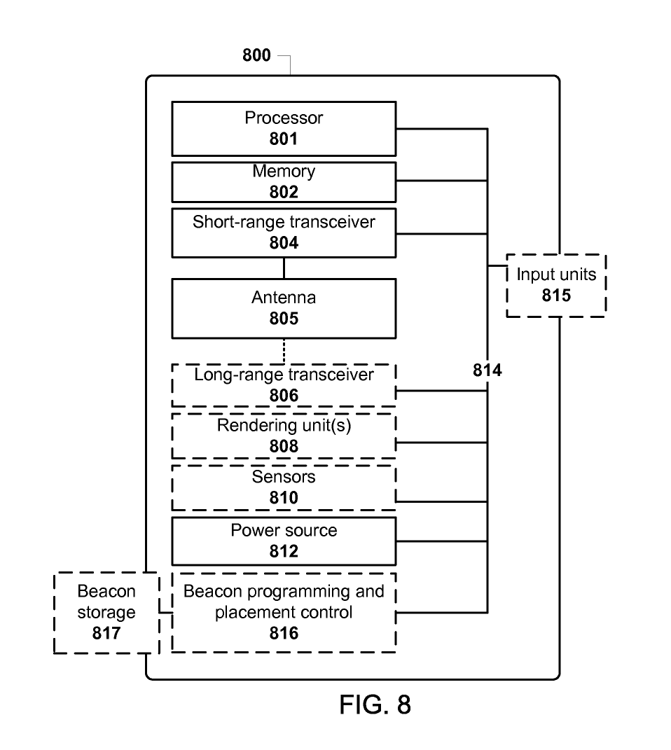

Components of an exemplary robot suitable for implementing the various embodiments are described below with reference to FIG. 8. In overview, robots may include memory for storing instruction sets and processors for executing such instructions. Robots may further include short-range communication components (or wireless signaling units), such as a radio transceiver (e.g., Bluetooth, Zigbee, RF, Wi-Fi, etc.) and antenna and/or other component(s) capable of emitting and/or receiving signals in sequences or patterns that may be recognized by other nearby devices with compatible communication units (e.g., a bulb or LED display, a speaker, a vibration motor, a microphone, a camera, a light sensor, a vibration sensor, etc.). In some embodiments, robots may also include long-range communication functionalities, such as long-range wireless signaling units (e.g., cellular network chip/modem and antenna) for communicating via wide area networks (WANs) using Internet protocol (IP) communications. This disclosure does not intend to limit the scope of the claims to robots having any particular type, class, manufacture, brand, configuration, functionality, and/or components, such as particular components for causing movement (e.g., locomotion), observation (e.g. scanning), and/or physical interactions (e.g., touching, etc.) with objects in various environments. For example, the embodiments of the disclosure may be applicable to both robots that cannot move independently (e.g., mounted to other devices or structures, etc.), that are capable of air movement (e.g., flying, gliding, etc.), and/or that are capable of terrestrial movement (e.g., walking, rolling, etc.).

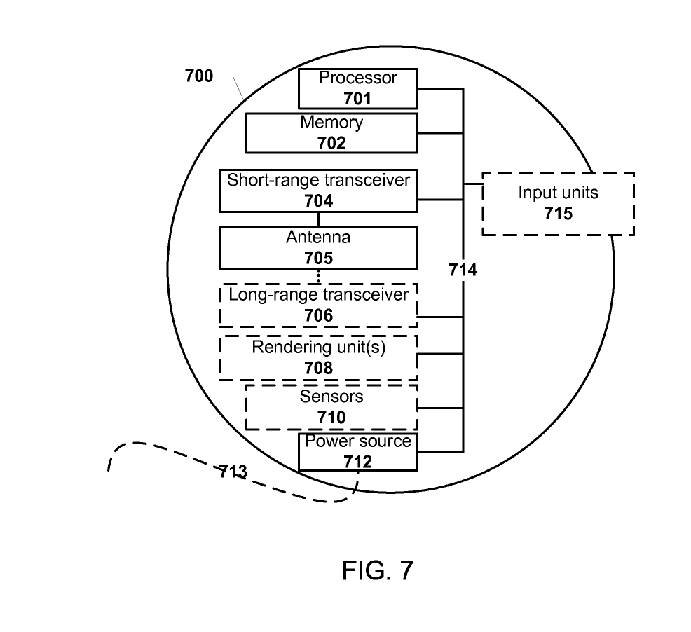

The term “beacon device” is used herein to refer to a communication device configured to broadcast or transmit data and/or instruction sets to robots within communication range, and receive data and/or instruction sets from robots within its communication range. For example, beacon devices may act as waypoints for robots within proximity of locations where the beacon devices are positioned. Components of an exemplary beacon device are described below with reference to FIG. 7. In overview, beacon devices may include a processor capable of executing stored data (e.g., routines for updating data to be transmitted within short-range wireless messages, etc.) and short-range communication components or transceivers (or wireless signaling units), such as Bluetooth, Zigbee, Wi-Fi, ultrasound, or infrared transceivers, and an antenna or other component for emitting and receiving wireless signals in sequences or patterns that may be recognized by other nearby devices with compatible communication units. In some embodiments, beacon devices may also include long-range communication components, such as long-range wireless signaling units (e.g., cellular network chip/modem and antenna) for communicating via wide area networks (WANs) using Internet protocol (IP) communications. Beacon devices may be mobile (e.g., carried on or affixed to moving items, such as robots) or stationary (e.g., placed in particular locations within buildings).

The term “deployment site” is used herein to refer to any area or place in which one or more robots may be deployed to perform various tasks. Deployment sites may include buildings (e.g., warehouses, etc.), campuses, commercial sites (e.g., construction sites, etc.), wilderness areas (e.g., a forest, a desert, etc.), bodies of water (e.g., oceans, lakes, etc.), airspaces, outer space, and/or any place where unmanned robots may be useful in conducting activities. The various embodiments may have particular utility in deployment sites where there is no or unreliable cellular network coverage, making uplinks or downlinks for robots and/or beacon devices to exchange data with a remote data source difficult or impossible.

The various embodiments provide methods, devices, systems, and non-transitory process-readable storage media for communicating configurable instruction sets to robots that may be updated/modified by a robot for communication to later arriving robots. In some embodiments configurable instruction sets may be transmitted by a beacon device for reception by robots, and the beacon devices and robots may be configured to enable such instruction sets to be updated by a nearby robot for subsequent presentation by the beacon device to other robots. The various embodiments enable a distributed information and instruction encoding framework to control robot behaviors that can accommodate unforeseen developments or obstructions. In some embodiments, a beacon device within (or near to) a deployment site may be configured to present (e.g., broadcast, render, etc.) data representing an instruction set (referred to herein as a “public instruction set”) that may be received by robots in proximity to the beacon device. Such a public instruction set may be relevant to the deployment site, including instructions for robots to execute to cause actions to be performed within the deployment site. For example, the public instruction set may include instructions for robots to make certain movements or scan certain sections within a wilderness area.

A robot in proximity to (i.e., within communication range of) the beacon device may receive the presented public instruction set, and as a result, may modify its locally stored instruction set based on the received public instruction set. For example, the robot may append operating steps to a routine, add and/or replace logic and/or functionalities (e.g., new checks/tests), and/or update parameters used in pre-programmed operations (e.g., remove variables from decision-making, etc.). In some embodiments, the robot may only have pre-established instructions enabling the robot to arrive at the beacon device's location where the robot may receive its next set of instructions for performing a mission. The robot may be configured to execute the instructions of the modified instruction set, causing the robot to perform various actions within the deployment site, such as scanning sections of an area with a sensor (e.g., a camera).

Based on the performance of such actions indicated within the modified instruction set, the robot may generate instruction set updates (e.g., different steps and/or values for variables (e.g., condition states), addition of instructions, removal of instructions, etc.) that may be presented to the beacon device for modifying its public instruction set. For example, a transmission from the robot may cause the beacon device's instructions to be updated to include directions (or a map) for traversing a path in a preferred or optimized path based on the robot's own operations, experiences and/or travels. The beacon device may subsequently present the public instruction set modified based on the update from the robot so that other robots may receive the modified public instruction set. In this way, actions and experiences of robots may be used to update instruction sets distributed to other nearby or later-arriving robots, avoiding the propagation of unnecessary, out-of-date instructions and improving the performance of tasks by robots within the deployment site.

The following is an example scenario that utilizes a beacon device that is configured to maintain and distribute a configurable public instruction set. A plurality of robots may be configured with pre-established (or pre-installed) instruction sets that enable the robots to perform mapping operations and may be deployed to a large building (e.g., an office building, a warehouse, etc.) having multiple sections (e.g., virtual divisions, rooms, etc.). At an entry to the building a first robot may encounter the beacon device configured to periodically broadcast the public instruction set via Bluetooth advertisement packets. The public instruction set may include instructions directing robots to map each of the sections of the building and return to the beacon device to report their progress. Based on receiving and executing the instructions of the public instruction set, the first robot may enter and map a first section of the building. Upon completing this mission, the first robot may return to the beacon device and transmit a message including information or an instruction set update to the beacon device. The beacon device may modify its public instruction set using the information or instruction set update from the first robot so that the public instruction set indicates all but the first section should still be mapped. When a second robot comes within proximity of the beacon device, it may receive and then execute the modified public instruction set, causing the second robot to bypass the first section and begin mapping a second section.

In various embodiments, beacon devices and robots may be configured to exchange data using various communication protocols and/mediums. For example, robots may be configured to transmit instruction set updates via RF signals (e.g., a Bluetooth communication link), sound signals or light signals (e.g., an infrared communication link). Robots and/or beacon devices may include various components and may use any combination of communication protocols and/or mediums for exchanging data. Thus, communications described in this disclosure are not intended to be limited to any one form of communication.

In some embodiments, beacon devices and/or robots may be configured to include additional information with their various communications. In particular, identifying information or other authentication data may be appended to communications (e.g., Bluetooth transmissions, etc.) of public instruction sets or instruction set updates. For example, in Bluetooth broadcast public instruction set messages, a beacon device may also include its unique device identifier and/or a password that may be used by recipient robots to determine whether the public instruction set is valid and thus can be trusted for installation and execution. As another example, the beacon device may receive a transmission via infrared (IR) light signaling from a robot that includes an instruction set update as well as a code indicating the type of robot the set is related to. In some embodiments, other characteristics of devices may be added to communications, such as conditions at a beacon device (e.g., position or coordinates, etc.) or a robot (e.g., remaining battery power, etc.).

In some embodiments, robots may be configured to carry (or generate), configure, and place (or deploy) beacon devices. For example, a robot configured to map an area may periodically drop beacon devices configured to transmit instruction sets that may cause subsequent robots to avoid mapping the same area. Such a robot may be pre-provisioned with a set of beacon devices that may be pre-programmed or programmed on-the-fly by the robot in response to its performance of an instruction set. For example, in response to updating a locally stored instruction set based on performing various actions, a robot may modify its instruction set and deploy a beacon device programmed to include that modified instruction set for subsequent broadcast. In some embodiments, the robot itself may function as a beacon device, such as by rendering or broadcasting instructions that may be received by other nearby robots.

In some embodiments, robots may be configured to dynamically print or otherwise generate static representations of instruction sets (or instruction set updates) that may be placed within a deployment site for subsequent use by other robots. For example, a robot may generate an instruction set update based on its actions within a deployment site, print a quick response (QR) code on a piece of paper, sticker, or other tangible medium, encoded with the instruction set update, and place the printed QR code on the ground, wall or other surface of the deployment site so that a later-arriving robot may scan the printed QR code and execute the instruction set update. In some embodiments, robots may be configured to replace static representations of instruction sets (or instruction set updates) previously generated by other robots. For example, a later-arriving robot may generate a second instruction set update in response to performing the instruction set update received from the printed QR code, print a second QR code on a second piece of paper encoding the second instruction set update, and place the second printed QR code near (e.g., on top of, over) the first printed QR code so that subsequently arriving robots may scan the second QR code and use the second instruction set update. In some embodiments, robots may be configured to place static representations of instruction sets in positions that may cause subsequent robots to read the instruction sets as replacements or edits of other instruction sets. For example, a robot may print and place a first QR code that represents an updated version of a set of instructions farther down a path than a second QR code that represents an outdated version of the set of instructions so that, as subsequent robots travel the path, the updated instructions will be read after the outdated instructions, thereby overwriting the older instruction set.

The embodiment techniques for updating robots within a deployment site based on other robots' activities may be beneficial for efficiently coordinating groups of robots generally configured to perform similar tasks. For example, for a group of robots tasked with conducting search-and-rescue operations on a mountaintop, the embodiment techniques may be beneficial in saving energy and time by allowing robots to be continually re-programmed to search in only areas of the mountaintop that have not already been reported as searched by other robots. As another example, when a beacon device is near a trash can and broadcasting a public instruction set message that indicates a first robot emptied the trash at a certain time (e.g., a last-emptied entry), a second robot may avoid wasting energy emptying the trash again.

The embodiment techniques may improve the functioning of robots by enabling the robots to be deployed with only a portion of programming pre-installed, thereby saving storage, reducing programming overhead and complexity, and improving power consumption of robots. By providing up-to-date instruction sets via beacon devices that are continually updated by other nearby robots, robots may save energy by avoiding unnecessary or redundant tasks that otherwise would not be reported as being completed. Further, by utilizing a system of beacon devices, behaviors of robots as defined by their instruction sets may be strategically re-programmed based on their current position/location at a given time, thus reducing the need for logic processes to determine appropriate operations to execute at a given time. Additionally, as embodiment techniques provide instruction set updates via short-range communications, robots may not require the components and/or the energy expenses of conducting long-range communications (e.g., via LTE cellular network, etc.) to retrieve updated instruction sets from remote data sources (e.g., remote servers), thus improving their power and operational efficiency.

The various embodiments provide techniques for robots to effectively re-program other nearby robots by updating instruction sets that may be distributed locally by beacon devices. These embodiment techniques are different from conventional techniques that utilize a central device to re-program and/or store data from robots. In particular, the various embodiments do not require a server to collect, manage, and distribute data to robots and/or beacon devices. Instead, the various embodiments provide beacon devices that communicate with robots using short-range communications to distribute instruction sets as well as receive updates to those instruction sets, thereby allowing local experiences of robots to inform instruction sets used by other robots within particular deployment sites. Without dependence on remote data sources, such as remote servers accessible via the Internet, the various embodiments enable dynamic programming of robots in environments in which long-range communications may be difficult or infeasible. Further, some embodiments are different from conventional techniques that utilize static waypoints, as the embodiment techniques enable robots to update beacon devices in a dynamic manner. For example, robots may transmit corrections, deletions, and/or additions to instructions broadcast by beacon devices based on already performed actions (e.g., sections of a site already scanned, etc.) or encountered conditions (e.g., position of moving obstacles, determination that path dead ends, optimal path data, etc.).

The following descriptions refer to beacon devices as storing, maintaining and transmitting a public instruction set for use by robots that are in its proximity. However, it should be understood that beacon devices may be capable of storing, maintaining, and presenting a plurality of instruction sets concurrently. For example, a beacon device may store a first public instruction set suitable for use by a first type of robot and a second public instruction set suitable for use by a second different type of robot, and may be configured to alternate the broadcast of Bluetooth messages that include the first public instruction set and Bluetooth messages that include the second public instruction set. Similarly, robots may be configured to utilize any number of instructions sets. For example, a robot may store and execute a first instruction set related to a first functionality (e.g., scanning) and a second instruction set related to a second functionality (e.g., movement). Thus, the various embodiments described herein should not be considered limited to any number of instruction sets on the various devices.

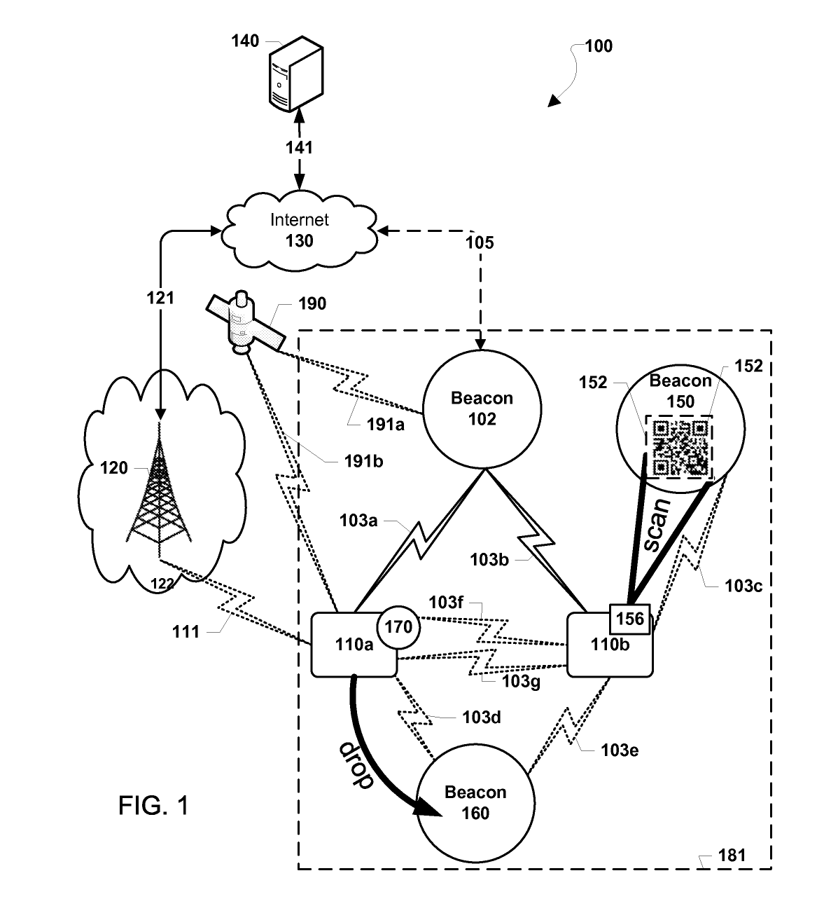

FIG. 1 illustrates an exemplary communication system 100 including a plurality of robots 110a, 110b and a plurality of beacon devices 102, 150, 160, 170 according to various embodiments. The beacon devices 102, 150, 160, 170 may be positioned within a deployment site 181, such as a building, a campus, a park, or a remote location (e.g., a forest, a desert, a mountaintop, ocean floor, etc.), to which the plurality of robots 110a, 110b are deployed to perform tasks. Further, the beacon devices 102, 150, 160, 170 may be configured to store, present (e.g., broadcast, render, etc.), and modify instruction sets that are executable by various robots 110a, 110b. For example, the beacon devices 102, 160, 170 may be configured to transmit messages including executable code via short-range signaling. Instruction sets may be related to the deployment site 181. For example, when the deployment site 181 is a wilderness area, an instruction set stored and transmitted by a first beacon device 102 may include instructions for causing robots 110a, 110b to map unmapped (or unknown) parts of the deployment site 181.

The beacon devices 102, 150, 160, 170 may be configured to exchange communications with the robots 110a, 110b via short-range wireless communications 103a-103f, such as via radio signals (e.g., Bluetooth, Wi-Fi signals, etc.), light signals, sound signals, vibration signals, and other forms of non-wired communication mediums. The beacon devices 102, 150, 160, 170, 110a, 110b may use such wireless communications to exchange instruction sets (or updated instruction sets), identifying information, and other data (e.g., sensor data, GPS coordinates, timestamps, etc.). For example, a first beacon device 102 may broadcast via Bluetooth advertisement packets a public instruction set via a first short-range wireless communication 103a that may be received by a first robot 110a and/or may establish a paired link via a second short-range wireless communication 103b to receive instruction set updates from a second robot 110b, or vice versa.

In some embodiments, beacon devices may be configured to render information that may be scanned or otherwise received by robots 110a, 110b within proximity. For example, a second beacon device 150 may be coupled to a display unit 153 configured to render imagery 152 (e.g., QR code, etc.) that represents a public instruction set. The imagery 152 may be scanned by the second robot 110b via a sensor 156 (e.g., a camera, light sensor, etc.) when the second robot 110b has a direct line-of-sight to the display unit 153 of the second beacon device 150. The second beacon 150 may also be configured to exchange wireless signals with the second robot 110b via a third short-range wireless communication 103c (e.g., a Bluetooth link or broadcast, etc.). In various embodiments, other rendered information may be detected by robots 110a, 110b. For example, the second beacon device 150 may emit sounds via a speaker that may be received via a microphone coupled to the second robot 110b. Further, in some embodiments as described above, robots 110a, 110b may be configured to render data (e.g., QR codes, etc.) that may be received at the beacon devices 102, 150, 160, 170 using various sensors (e.g., cameras, microphones, light sensors, etc.).

In some embodiments, robots may be configured to program and deploy beacon devices. In other words, a robot may have one or a plurality of beacon devices that may be programmed based on instruction sets (and/or instruction set updates) stored on the robot and placed within the deployment site 181 for interacting with other robots that may subsequently come within proximity of the placed beacon devices. For example, the first robot 110a may be configured to drop (or place) a third beacon device 160 from a storage device (e.g., a holder, rack, etc.) coupled to the first robot 110a. Once the third beacon device 160 is deployed, it may begin exchanging data with the first robot 110a and/or the second robot 110b via short-range wireless communications 103d, 103e. In this manner, robots may periodically place beacon devices as “bread crumbs” that may provide incremental data to other robots as they travel by.

Various beacon devices may be stationary or semi-stationary (i.e., capable of being moved but having no components enabling movement). For example, the first beacon device 102 may be positioned within a building and coupled to a power supply (e.g., plugged into an outlet of the building), whereas the third beacon device 160 may be placed on a rock by the first robot 110a. In some embodiments, beacon devices may be affixed to moving objects. For example, a fourth beacon device 170 may be attached to (or located within) the first robot 110a, and thus will move from place to place along with the first robot 110a. The fourth beacon device 170 may be capable of exchanging information with the second robot 110b via the short-range wireless communications 103f.

In some embodiments, robots may also be configured to act as beacon devices. For example, the first robot 110a may be configured to exchange data (e.g., instruction set updates, entire instruction sets, etc.) with the second robot 110b via a short-range wireless communications 103g (e.g., Bluetooth messaging).

In some embodiments, robots and/or beacon devices may include location-determining capabilities, such as global positioning system (GPS) receivers. For example, the first beacon device 102 and/or the first robot 110a may each include a GPS receiver that receives data (e.g., coordinates) from a GPS satellite in orbit overhead.

As described above, one advantage of the various embodiment beacon devices is that they may provide instruction sets that can be updated or re-programmed by robots that are within proximity without requiring a connection to any remote data source. For example, when placed in a wilderness deployment site 181 with no wide area network (WAN) connectivity, the beacon devices 102, 150, 160, 170 may receive updates to their stored instruction sets transmitted by the robots 110a, 110b via the short-range wireless communications 103a-103f. However, in some embodiments, beacon devices may include functionalities for communicating with wide area networks (WANs). For example, the first beacon device 102 may include a long-range transceiver and antenna capable of establishing a connection 105 to the Internet 130, which in turn may enable the first beacon device 102 to communicate with a remote server 140 that is connected to the Internet 130 via a wired or wireless connection 141. In some embodiments, the connection 105 may be via long-range, cellular network connection. Similarly, robots may also be configured to utilize WAN connections when available. For example, the first robot 110a may include a transceiver and antenna capable of exchanging communications, via a long-range wireless connection 111, with a base station 120 of a cellular network 122 connected to the Internet 130 via a connection 121.

Such WAN functionalities of beacon devices and/or robots may be useful for devices that are moveable, allowing but not requiring these devices to communicate with remote data sources whenever WAN connectivity is available. For example, when the first beacon device 102 is eventually moved from a remote deployment site 181 (e.g., a forest) to another site (e.g., a mountain), the first beacon device 102 may be able to report collected data and/or receive new instruction sets from the remote server 140 if and when a WAN connection becomes available (e.g., the first beacon device 102 is moved through an area with cellular network coverage).

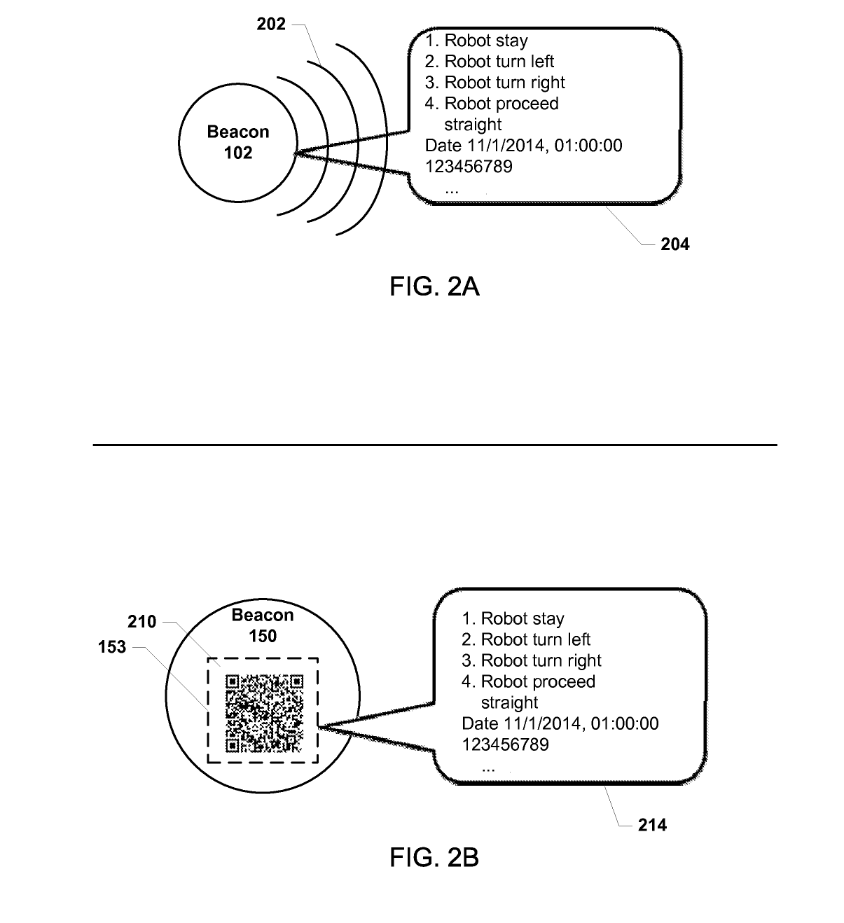

FIGS. 2A-2B illustrate exemplary instruction sets 204, 214 provided by beacon devices 102, 150, such as described with reference to FIG. 1. The instruction sets 204, 214 may include a plurality of steps, commands, codes, routines, variables, and/or other actionable (or executable) information that robots within proximity may utilize to carry out various actions or tasks. For example, the instruction set 204 may include commands directing a robot to stay, turn left, turn right, and then proceed straight. Instruction sets may not be complete programming for a robot and/or for a particular task, such as path finding, but instead may be a segment of programming or instructions that the robot may use to supplement its pre-existing programming or instructions. For example, the robot may already possess programming enabling it to move within proximity of a beacon device prior to receiving an instruction set indicating the robot should continue to perform various movements.

Referring to FIG. 2A, an embodiment beacon device 102 may be configured to generate wireless signaling 202, such as connectionless Bluetooth advertisement packets, that indicate the instruction set 204. Such wireless signaling 202 may be according to various radio communication protocols or standards, such as Bluetooth, Zigbee, Wi-Fi, etc., or other kinds of wireless signaling, such as via light (e.g., visible and non-visible light), sound (e.g., ultrasound), heat, vibrations, etc.

Referring to FIG. 2B, another embodiment beacon device 150 may be configured to render imagery (e.g., a QR code 210) via a display unit 153 that may be scanned and processed (e.g., decoded) by robots to obtain the instruction set 214. Alternatively, a QR code 210 encoding the instruction set may be printed or posted on a location, and robots arriving at the location may scan the QR code 210 to receive the instructions.

In some embodiments, the instruction sets 204, 214 may also include information that may be used by a receiving robot to determine whether the instruction sets 204, 214 are valid, current and/or trustworthy, such as a timestamp (illustrated as “Date Nov. 1 2014, 01:00:00”) and/or a hash value (illustrated as “123456789”), secret word, or other data that may be used (e.g., with a hash function) to confirm the authenticity of the instruction sets 204, 214 or the messaging used to deliver the instruction sets 204, 214.

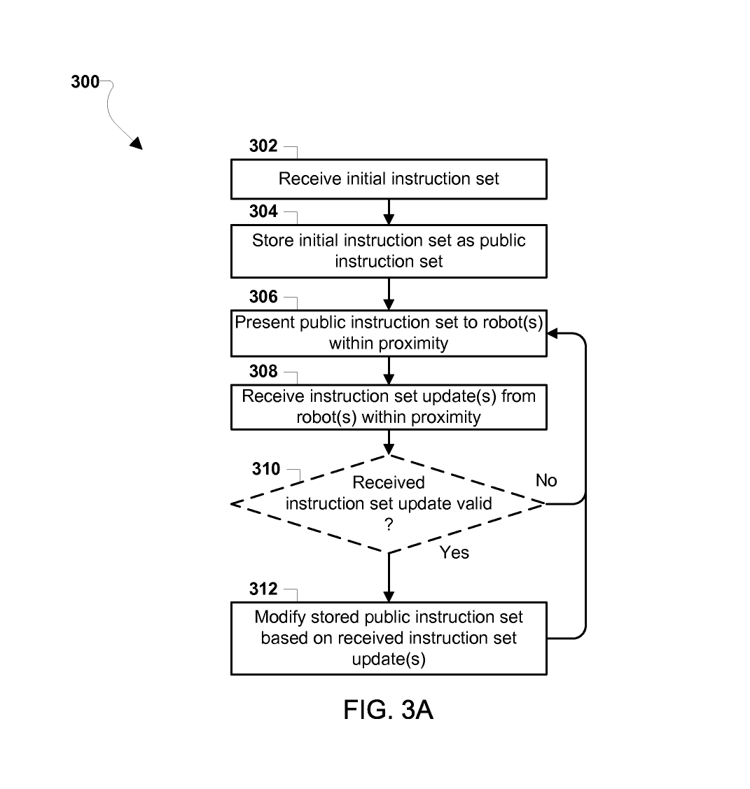

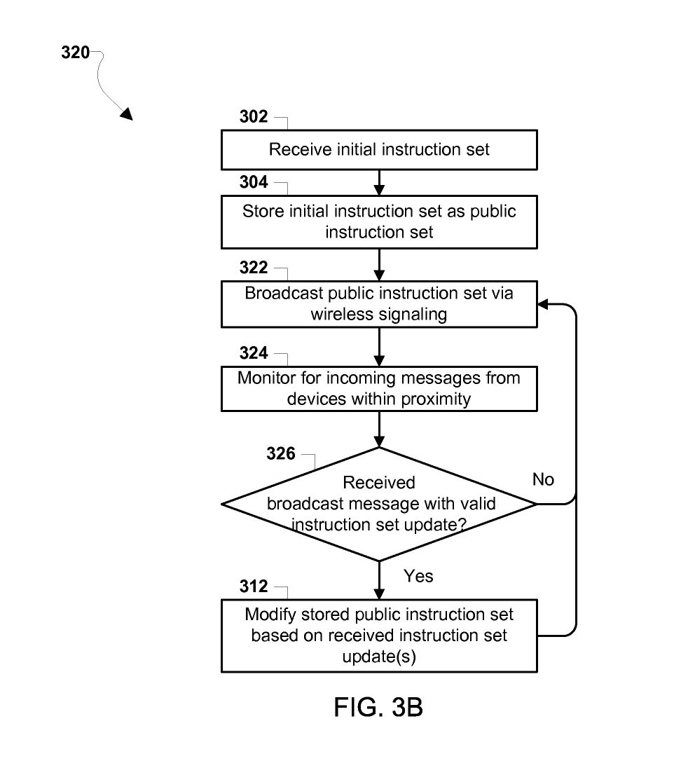

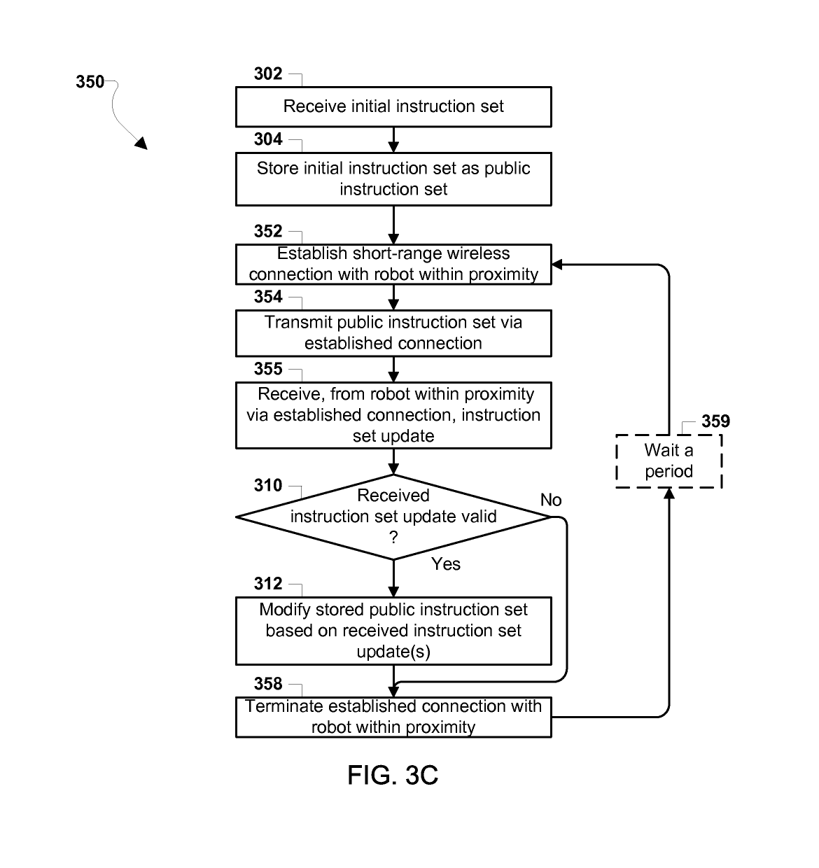

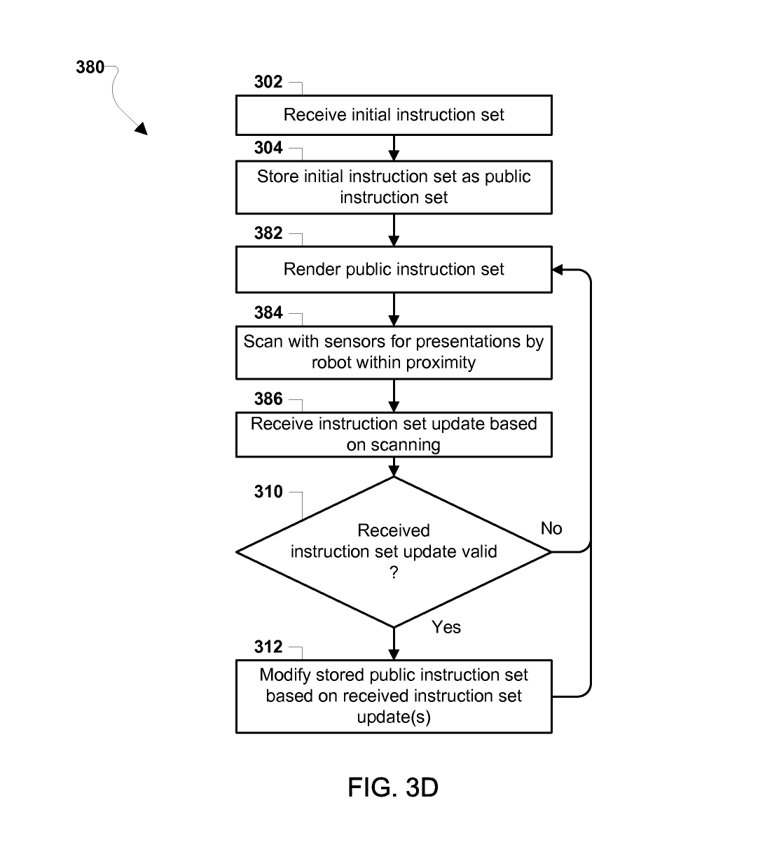

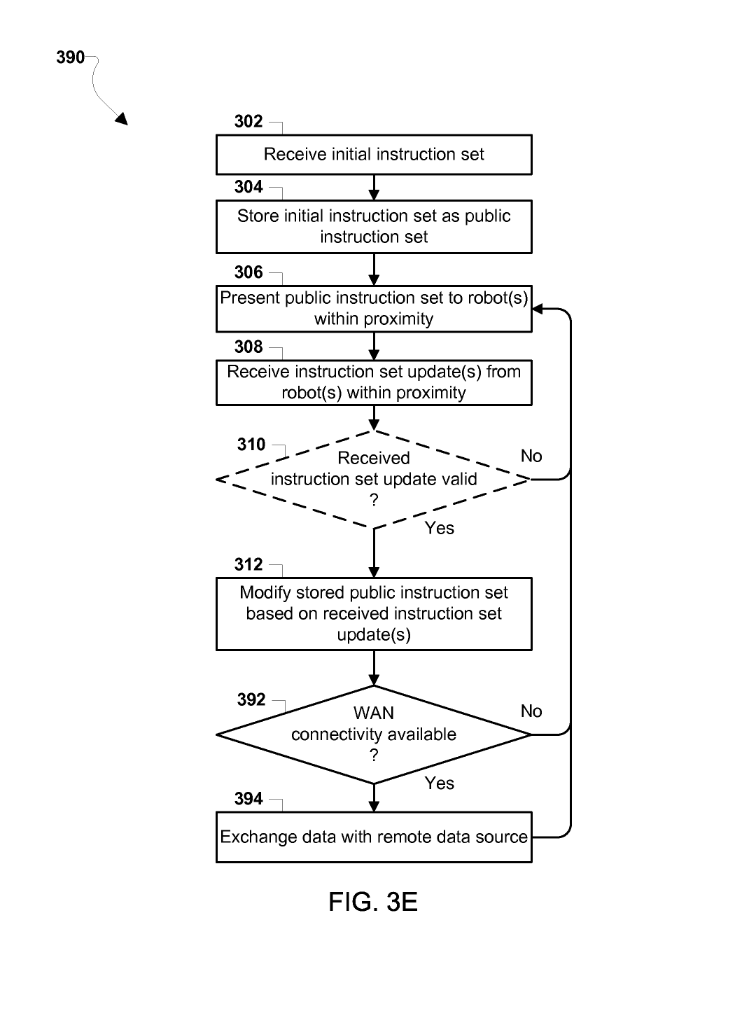

FIGS. 3A-3E illustrate embodiment methods 300, 320, 350, 380, 390 for a beacon device to provide public instruction sets to and/or receive instruction set updates from robots within proximity. The methods 300, 320, 350, 380, 390 may be performed by a beacon device, such as described above with reference to FIG. 1, using a processor (e.g., the processor 701 as described with reference to FIG. 7) executing various modules, software, instructions, code, and/or routines.

With reference to FIG. 3A and FIGS. 1-2B, 7, the processor of the beacon device may receive an initial instruction set in block 302. For example, the instruction set may be installed or otherwise transmitted to the beacon device by a manufacturer. In some embodiments, the beacon device may utilize short-range communications (e.g., Bluetooth, Wi-Fi, etc.) or long-range communications (e.g., cellular network communications) to receive the initial instruction set. For example, the beacon device may receive the initial instruction set via a Wi-Fi local area network (LAN) within a manufacturing facility. As another example, prior to being placed within a deployment site that does not have reliable long-range communication capabilities (e.g., no Internet or cellular network access), the beacon device may receive the initial instruction set via a cellular network while in transit to the deployment site. In some embodiments, the initial instruction set may be received at the beacon device via user inputs, such as touch inputs on a touch screen coupled to the beacon device and/or other inputs (e.g., via a keyboard or keypad) provided by a service technician, a programmer, or other user.

In block 304, the processor of the beacon device may store the initial instruction set as a public instruction set. The public instruction set may be a version of the instruction set that the beacon device stores as acceptable for sharing with other devices. In other words, the public instruction set may be the latest (or most current) instruction set accessible to the beacon device that the beacon device is authorized to distribute to nearby robots. In some embodiments, the beacon device may perform operations to confirm an instruction set (or update to an instruction set) works properly prior to storing it as the public instruction set. For example, in order to store any instruction set (or update) as the current public instruction set, the beacon device may perform various confirmation routines or checks, such as debugging, authorization checks, and/or timestamp evaluations. In some embodiments, the beacon device may be configured to store, maintain, and distribute a plurality of public instruction sets, such as a public instruction set for each of a plurality of different types of robots. In some embodiments, the beacon device may be configured to store, maintain, and distribute a plurality of public instruction sets for each type of robot, such as a different instruction set for various functionalities of particular types of robots (e.g., one set for moving, one set for a particular component functionality, etc.).

In block 306, the processor of the beacon device may present the public instruction set to robot(s) within proximity, such as by wirelessly transmitting (e.g., periodically broadcasting) or rendering imagery, transmitting light, generating vibrations, and/or emitting sound that encodes the instruction set. Such presentations of the public instruction set (e.g., broadcasts, transmissions, rendered data, etc.) may also include various data that may be used to indicate the source of the presented data (e.g., the identity or ‘device ID’ of the beacon device, GPS coordinates of the beacon device, the owner of the beacon device, etc.), to authenticate the information and/or instruction sets (e.g., passwords, hashes, codes, etc.), to provide context or relevance for information and/or instruction sets (e.g., codes of the types, brands/makes of robots that may use the instruction set, etc.), and/or to provide other information indicating the freshness (e.g., timestamp) or validity of the public instruction set. For example, as illustrated in FIGS. 2A-2B, a public instruction set may be presented as a broadcast message or rendered QR code that encodes executable steps for a robot in combination with timestamp and/or authentication data (e.g., a hash that may be used by a receiving robot to confirm authenticity of the encoded information). Various manners of information presentation are described below. In block 308, the processor of the beacon device may receive instruction set update(s) from robot(s) within communication range. For example, the beacon device may receive Bluetooth broadcast messages and/or scan for presentations of data from nearby robots. Various manners of receiving instruction set updates are described below.

In optional determination block 310, the processor of the beacon device may determine whether the received instruction set update is valid. In other words, the beacon device may process any received messages or other data to determine whether they include codes, text, symbols, and/or other data that is associated with a valid (e.g., working) instruction set update from a nearby robot. For example, the beacon device may perform operations to parse and evaluate data packets received via a Bluetooth connection to identify whether the packets include executable code related to the public instruction set currently stored on the beacon device. Valid instruction set updates may be instruction sets or portions of instruction sets that are capable of being executed (e.g., error-free) by robots as part of or in replacement of the current public instruction set. Valid instruction set updates may include codes or other identifying information that indicate the updates are related to types, classes, or brands of robots supported by the beacon device.

In some embodiments, in order to determine whether a received instruction set update is valid, the beacon device may evaluate authentication data received with the received instruction set update to determine whether the update is authentic. For example, the beacon device may identify a sender device identifier within a received instruction set update and compare that device identifier to a list of known or approved devices in order to determine whether the received instruction set update can be trusted and thus shared with other robots. As another example, the beacon device may evaluate a received message to determine whether a secret word, hash, or password is included that authenticates the included instruction set update. In some embodiments, received messages from nearby robots may include a hash of the instruction set and other data in the message generated by a hash algorithm known to the robot that the robot can compare to a hash it generates from the received message using the same hash algorithm in order to validate the contents of the received instruction set update message. For example, when a robot and the beacon device are configured to utilize the same secret function (or secret configuration of a hash function), a hash value generated on the robot using the secret function may be shared for comparison with data generated on the beacon device using the same secret function such that matching hash values can be used to confirm the validity of the message with the instruction set update.

In some embodiments, the beacon device may determine a received instruction set update is valid in response to successfully compiling the instruction set update in combination with or separate from the public instruction set. For example, when the received instruction set update cannot be merged into the public instruction set to create a functional, executable set of instructions for robots to perform, the instruction set update may not be valid. As another example, instruction set updates may be determined invalid when they include corrupted data, syntax issues, and/or other functional flaws.

In some embodiments, the beacon device may determine a received instruction set update is valid based on timestamp data associated with the instruction set update. For example, when an instruction set update (e.g., a set of commands, codes, or other data) has a timestamp older than the current timestamp of the public instruction set stored on the beacon device, the beacon device may determine the instruction set update invalid.

In response to determining that the received instruction set update is not valid (i.e., optional determination block 310=“No”), the beacon device may continue presenting the original public instruction set in block 306. In various embodiments, the beacon device may delete or otherwise invalidate any stored data associated with an invalid received instruction set update.

In response to determining that a valid instruction set update is received from a robot within proximity (i.e., optional determination block 310=“Yes”), the processor of the beacon device may modify the stored public instruction set based on the received instruction set update in block 312. For example, the beacon device may merge, append, and/or replace segments or the entirety of the previous public instruction set with the received instruction set update. The beacon device may also update a timestamp of the stored public instruction set to represent that the public instruction set has been modified, such as by changing a date or time indicator associated with the public instruction set to indicate a timestamp included within the received instruction set update. In some embodiments, such timestamps may be stored on a per-segment basis to indicate different dates of different segments of the entirety of the public instruction set. For example, individual methods, code blocks, and/or variables of the public instruction set may be associated with timestamps that may be compared with subsequently received instruction set updates to determine further valid updates. The beacon device may present the now modified public instruction set in block 306 for.

FIG. 3B illustrates an embodiment method 320 for a beacon device to provide public instruction sets to and/or receive instruction set updates from robots within proximity. The method 320 is similar to the method 300 described with reference to FIG. 3A, except that the method 320 may include operations for the beacon device to present and/or receive data via short-range wireless broadcast messages (e.g., advertisement packets, etc.). For example, public instruction sets may be broadcast and/or instruction set updates may be received via connectionless Bluetooth broadcasts.

The operations performed in blocks 302-304, 312 may be similar to those described above for like numbered blocks. In block 322, the processor of the beacon device may broadcast the public instruction set via wireless signaling, such as by periodically broadcasting, via a short-range wireless transceiver and antenna, messages indicating the instructions of the public instruction set via Bluetooth, RF, Wi-Fi Direct, or other wireless communication protocols or standards. For example, the broadcast may be a packet (or packet stream) that includes codes or other data that may be received and recognized by robots within proximity to indicate corrections, deletions, and/or additions to instruction sets typically utilized by a certain type, class, manufacture, and/or model of robot. The broadcasting may be similar to the presenting of the public instruction set described above with reference to block 306, except that the broadcasting may explicitly address connectionless messaging.

In block 324, the processor of the beacon device may monitor for incoming messages from devices within proximity, such as incoming Bluetooth broadcasts from robots. The beacon device may be configured to continually evaluate an incoming message buffer to identify any received wireless communications. For example, the beacon device may monitor a buffer to determine whether a connectionless Bluetooth advertisement packet or pairing communication has been received from a robot. In some embodiments, the beacon device may be configured to utilize various sensors to scan for signaling from devices within proximity, such as robots. For example, the beacon device may periodically activate a camera, microphone, heat sensor, and/or light sensor to detect signaling from nearby robots.

Based on the monitoring operations, in determination block 326, the processor of the beacon device may determine whether it has received a broadcast message that includes a valid instruction set update from a robot within proximity. The operations in determination block 326 may be similar to those described with reference to optional determination block 310 in FIG. 3A. For example, the beacon device may evaluate the syntax, ability to be compiled (or executed), a timestamp, and/or authentication data within a received broadcast message to determine whether it is a valid update. In response to determining that no broadcast message is received that includes a valid instruction set update (i.e., determination block 326=“No”), the beacon device may continue broadcasting the public instruction set in block 322.

In response to determining that a broadcast message is received that includes a valid instruction set update (i.e., determination block 326=“Yes”), the beacon device may modify the stored public instruction set in block 312 and broadcast the modified stored public instruction set in block 322.

FIG. 3C illustrates an embodiment method 350 for a beacon device to provide public instruction sets to and/or receive instruction set updates from robots within proximity. The method 350 is similar to the method 300 described with reference to FIG. 3A, except that the method 350 may include operations for the beacon device to present and receive data (e.g., present public instruction sets to robots, receive instruction set updates from robots) via established short-range wireless connections, such as a Bluetooth connection between paired devices, instead of via broadcast messages or other data transmissions.

The operations performed in blocks 302-304, 310, and 312 may be similar to those described above for like numbered blocks. In block 352, the processor of the beacon device may establish a short-range wireless connection with a robot within proximity. For example, in response to receiving an indication that the robot within proximity is available to communicate, the beacon device may perform operations to establish a Bluetooth paired link with the robot. In various embodiments, establishing such a connection may require that the robot and beacon device be predefined to one another, such as based on a previous pairing operations, or alternatively that the devices authenticate each other, such as based on exchanging predefined credentials or passwords.

In block 354, the processor of the beacon device may transmit the public instruction set via established connection. In block 355, the processor of the beacon device may receive, from a robot within proximity via the established connection, an instruction set update. As described with reference to FIG. 3A, the beacon device may determine whether the received instruction set update (e.g., the update received via the established connection) is valid in determination block 310. The operations of determination block 310 may be similar to the operations in the like numbered block described above with reference to FIG. 3A, except that the determination may regard instruction set updates received via the established connection instead of via connectionless communications, such as Bluetooth advertisements packets, or other mediums of messaging. In response to determining that a valid instruction set update is received (i.e., determination block 310=“Yes”), the processor of the beacon device may modify the stored public instruction set based on the received, valid instruction set update in block 312 as described above with reference to FIG. 3A.

In response to determining that no valid instruction set update is received (i.e., determination block 310=“No”), or performing the operations in block 312, the beacon device may terminate the established connection with the robot within proximity in block 358. In optional block 359, the processor of the beacon device may wait a period before establishing short-range wireless connections with other robots within proximity in block 352.

FIG. 3D illustrates an embodiment method 380 for a beacon device to provide public instruction sets to and/or receive instruction set updates from robots within proximity. The method 380 is similar to the method 300 described with reference to FIG. 3A, except that the method 380 may include operations for the beacon device to present data (e.g., public instruction sets to robots) via rendering units (e.g., displays, speakers, light sources, vibration motors, etc.) and to receive data (e.g., instruction set updates from robots) via various sensors (e.g., cameras, microphones, light sensors, vibration sensors, etc.).

The operations in blocks 302-304, 310, and 312 may be similar to those described above for like numbered blocks. In block 382, the processor of the beacon device may render the public instruction set, such as by displaying a QR code, a bar code, a pattern, and/or images on a screen (e.g., an LED screen), by playing a series of sounds, tweets, or noises via a speaker, by vibrating in certain patterns via a motor, and/or by emitting a series of flashing lights via a light source (e.g., a bulb), etc. For example, the beacon device may display on a screen a QR code representing the public instruction set. As another example, the beacon device may flash a bulb in a pattern to indicate the public instruction set in a manner similar to Morse code. In various embodiments, the beacon device may use any of a plurality of units (e.g., display, speaker, etc.) to present various types of signaling to nearby robots, such as any or all of a display, a speaker, a vibration motor, and/or a light source.

In block 384, the processor of the beacon device may scan with sensors for presentations by a robot within proximity. For example, the beacon device may use a camera to capture imagery of lights emitted in various sequences or patterns by a nearby robot. As another example, the beacon device may use a microphone to detect sound signaling from a nearby robot. In various embodiments, the beacon device may use any in a plurality of sensor to detect various types of signaling from nearby robots, such as any or all of a camera, a microphone, a light sensor, and/or a vibration sensor. In block 386, the processor of the beacon device may receive an instruction set update based on the scanning. For example, the beacon device may be configured to perform image processing routines that evaluate scanned imagery to identify symbols, patterns, and/or other information that may be used to identify instructions, code, and/or other data that may be used to adjust and/or replace its currently stored public instruction set. In some embodiments, the beacon device may be configured to process and convert the scanned information into executable code.

As described above with reference to FIG. 3A, in determination block 310 the beacon device may determine whether the received instruction set update (e.g., the update received via the scanning) is valid. The operations of determination block 310 may be similar to those of the like numbered block described above with reference to FIG. 3A, except that the determination may regard instruction set updates received via the sensor scanning. In response to determining that a valid instruction set update is received (i.e., determination block 310=“Yes”), the processor of the beacon device may modify the stored public instruction set based on the received, valid instruction set update in block 312 as described above with reference to FIG. 3A.

In response to determining that no valid instruction set update is received (i.e., determination block 310=“No”), or performing the operations in block 312, the beacon device may render the public instruction set (or modified public instruction set) for receipt by robots within proximity in block 382.

FIG. 3E illustrates an embodiment method 390 for a beacon device to provide public instruction sets to and/or receive instruction set updates from robots within proximity of the beacon device. The method 390 is similar to the method 300 described with reference to FIG. 3A, except that the method 390 may include operations for the beacon device to exchange data with a remote data source when a wide area network (WAN) connection is available. For example, when the beacon device is within an area having cellular network coverage, the beacon device may communicate with a cloud server, such as by transmitting access logs and/or receiving instruction set updates or other software to be executed at the beacon device and/or relayed to nearby robots.

The operations in blocks 302-312 may be similar to those described above for like numbered blocks. In determination block 392, the processor of the beacon device may determine whether a wide area network connectivity is available, such as by determining whether a signal strength of signals from cellular network base stations is above a predefined threshold and/or whether there are any predefined (e.g., authorized, authenticated, etc.) access points that may be connected to. In other words, the beacon device may periodically determine whether it is within an area with WAN coverage or has gained or recovered access to the Internet or other WAN. In some embodiments, the WAN connectivity may be determined based on whether the beacon device can connect to a local area network (LAN) that provides WAN access. In response to determining that there is no WAN connectivity available (i.e., determination block 392=“No”), the beacon device may continue with the operations in block 306 as described above.

In response to determining that there is WAN connectivity available (i.e., determination block 392=“Yes”), the processor of the beacon device may exchange data with a remote data source in block 394, such as a cloud server. For example, the beacon device may provide updated activity data (e.g., messages sent, messages received, timestamps, etc.) to a server via the Internet for storage. As another example, the beacon device may receive applications, instructions, and other data from the remote source that may be executed locally by the beacon device and/or provided to nearby robots. In some embodiments, the beacon device may modify stored public instruction sets based on data exchanged with the data source. The beacon device may continue with the operations for presenting the public instruction set to robots within proximity in block 306 as described above.

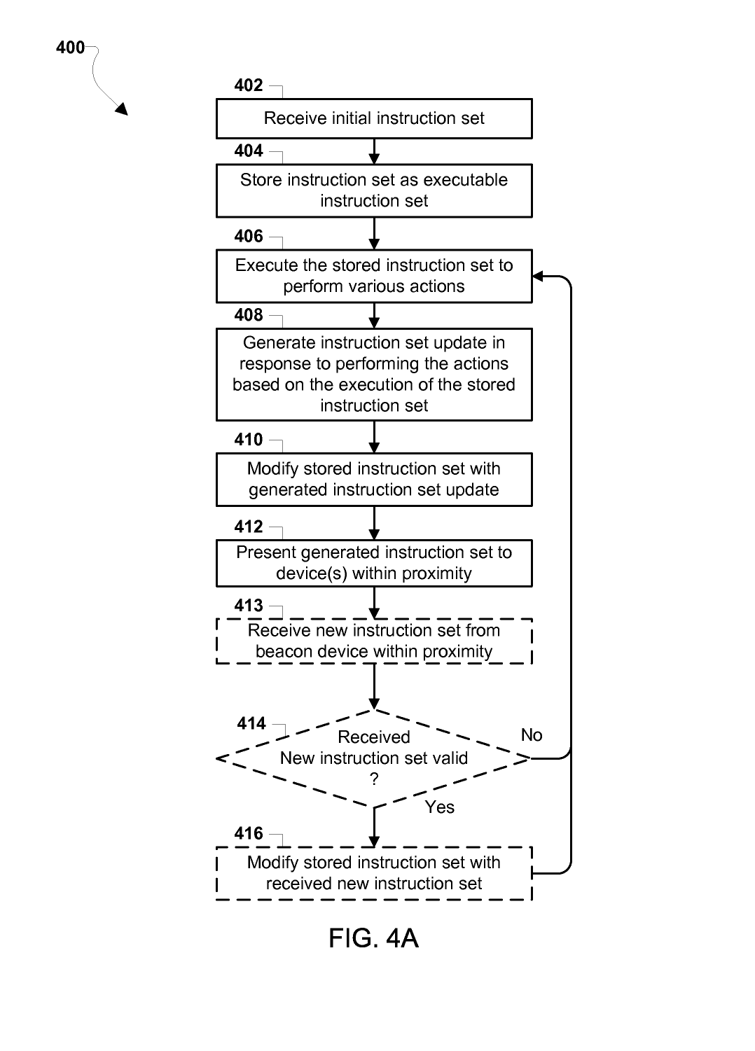

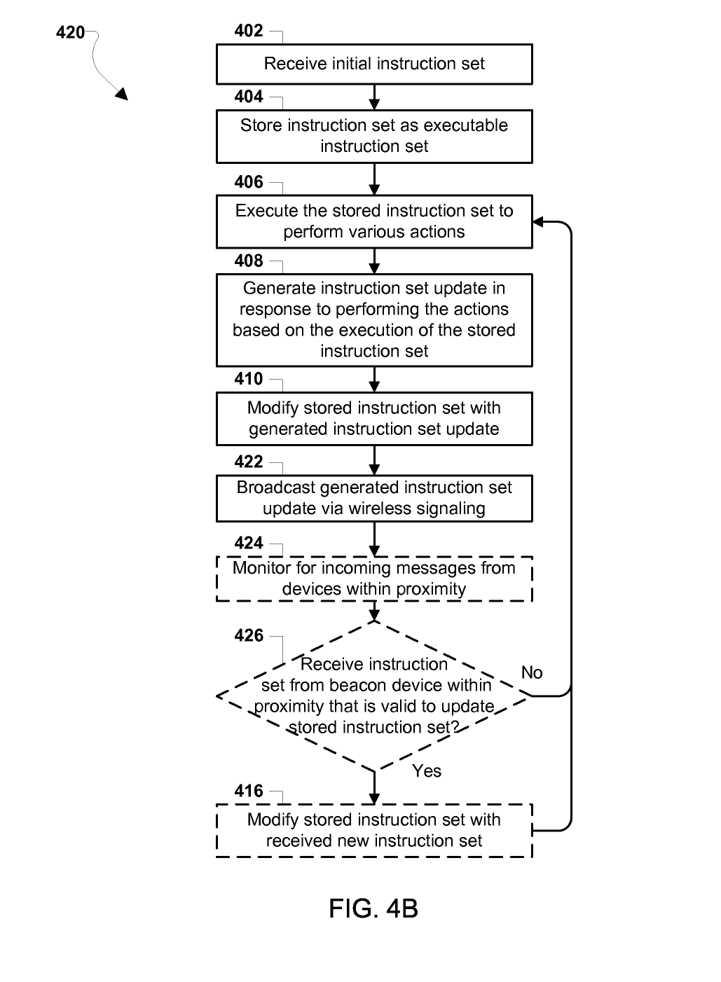

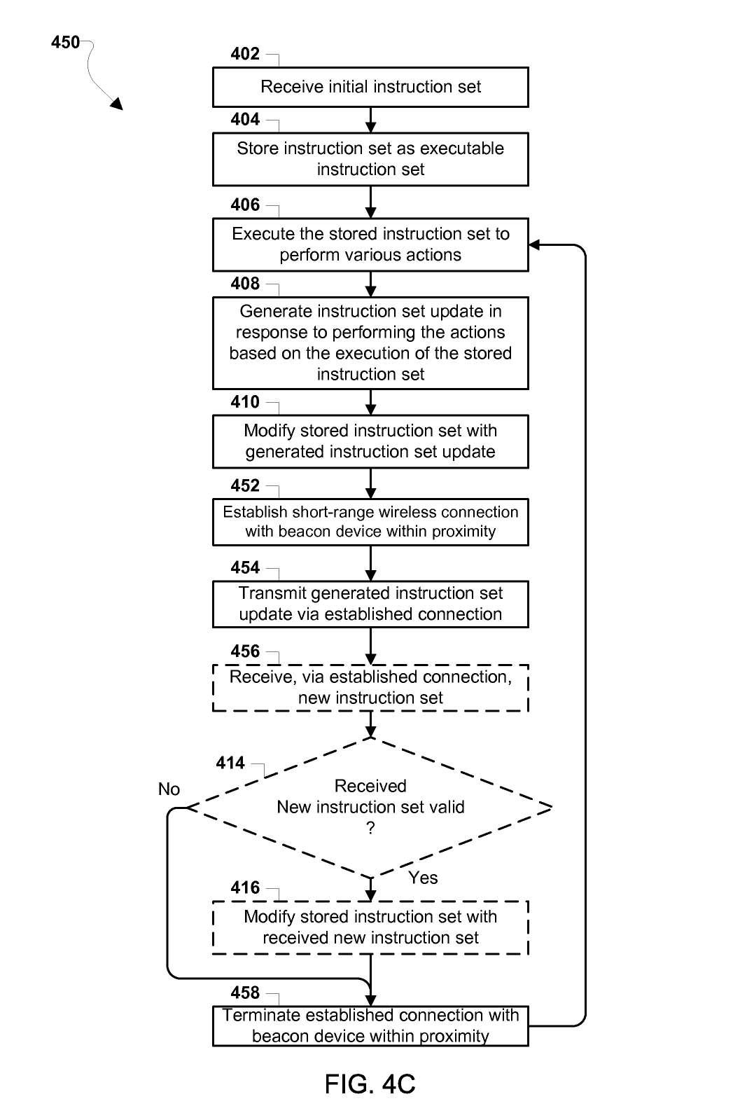

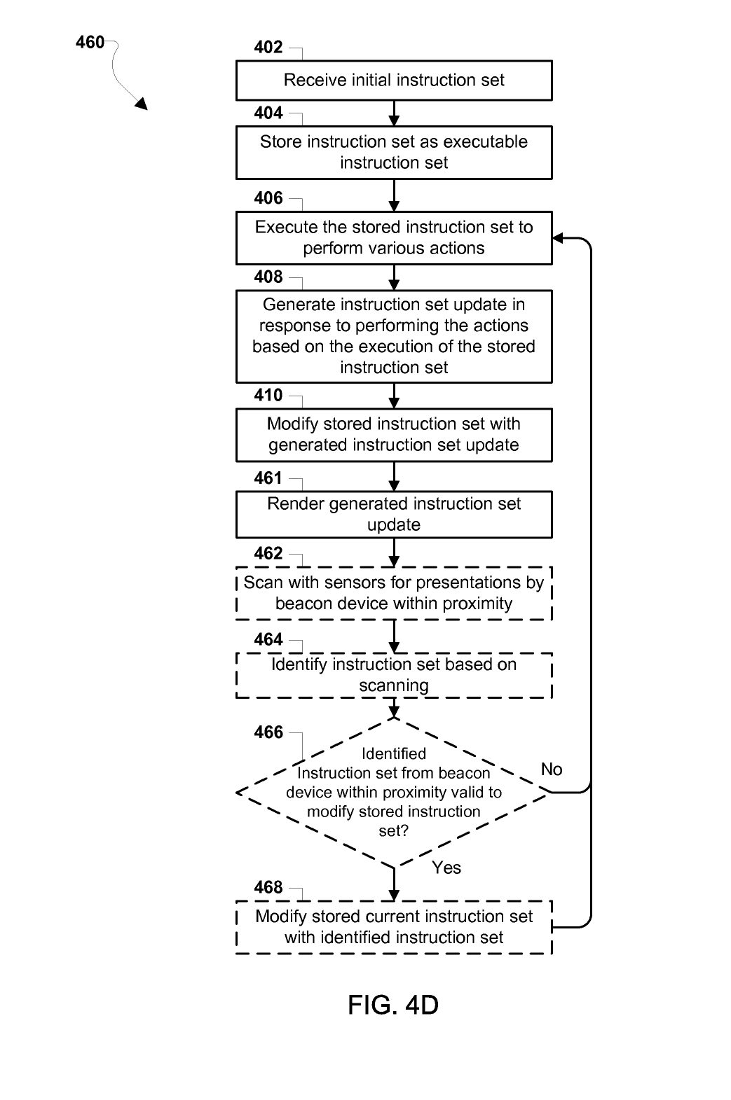

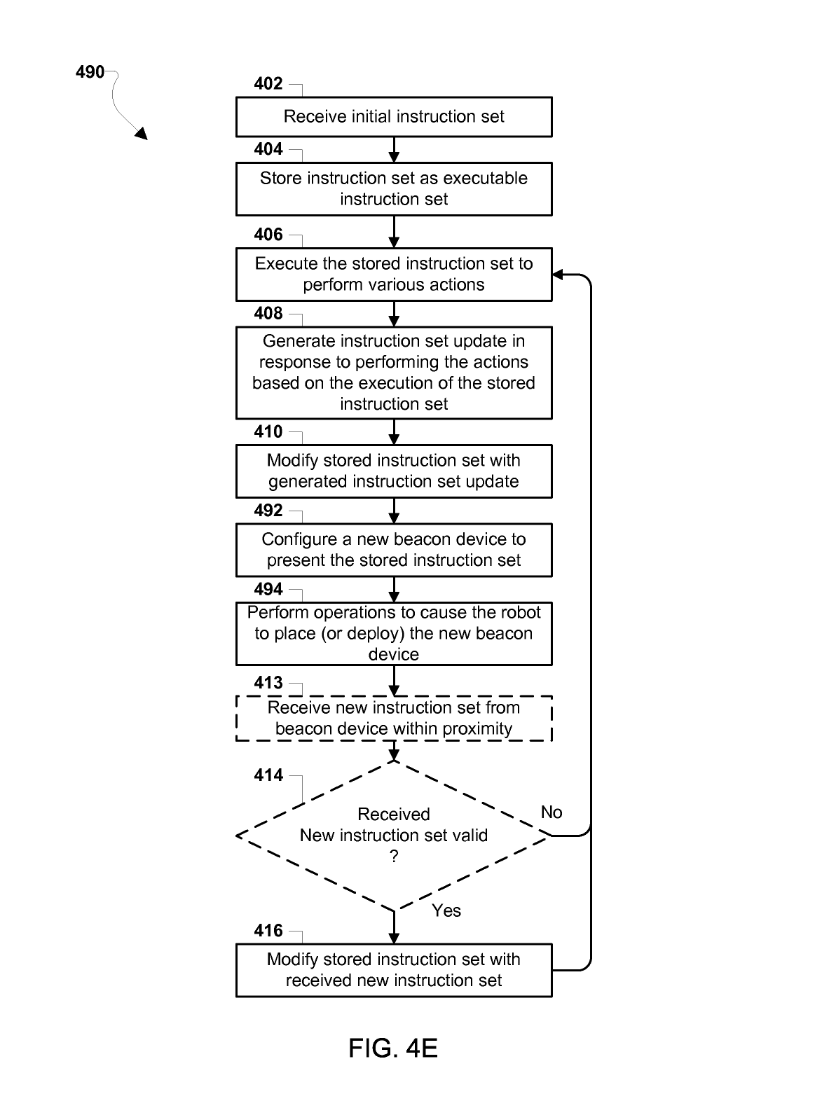

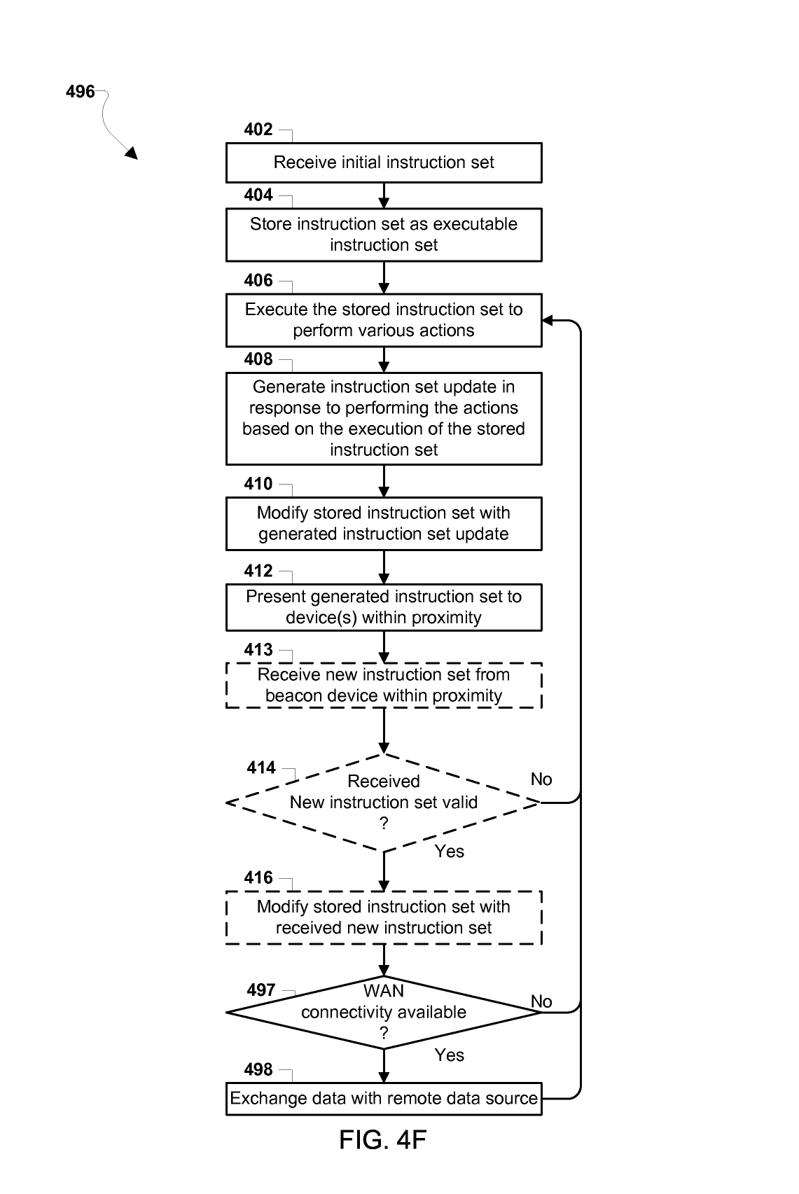

FIGS. 4A-4F illustrate embodiment methods 400, 420 450, 460, 490, 496 for a robot to receive instruction sets from and/or provide instruction set updates to beacon devices within proximity. The methods 400, 420, 450, 460, 490, 496 may be performed by a robot, such as described with reference to FIG. 1, using a processor (e.g., the processor 801 as described with reference to FIG. 8) executing various modules, software, instructions, code, and/or routines.

Referring to FIG. 4A, the processor of the robot may receive an initial instruction set in block 402. For example, the instruction set may be installed or otherwise transmitted to the robot by a manufacturer. In various embodiments, the initial instruction set may be similar to instruction sets installed or otherwise stored by similar robots. In other words, the initial instruction set may include common programming or directions that guide the behavior of a community of robots. For example, the initial instruction set for a first robot may to be deployed to a particular deployment site (e.g., a mountain top) include the same information (or instructions) as the initial instruction set for a second robot to be deployed to the particular deployment site. In some embodiments, the robot may utilize short-range communications (e.g., Bluetooth, Wi-Fi, etc.) or long-range communications (e.g., cellular network communications) to receive the initial instruction set. For example, the robot may receive the initial instruction set via a Wi-Fi local area network (LAN) within a manufacturing facility. As another example, prior to being placed within a deployment site that does not have reliable long-range communication capabilities (e.g., no Internet or cellular network access), the robot may receive the initial instruction set via a cellular network while in transit to the deployment site. In some embodiments, the initial instruction set may be received at the robot via user inputs, such as touch inputs on a touch screen coupled to the robot and/or other inputs (e.g., via a keyboard or keypad) provided by a service technician, a programmer, or other user.

In block 404, the processor of the robot may store the received initial instruction set as an executable instruction set. In other words, the initial instruction set may be stored in memory as programs, applications, routines, and/or instructions that the robot may execute during its normal operations when deployed. For example, the stored instruction set may include the instructions for causing the robot to move to a particular deployment site (e.g., a certain building, a certain location in a grid, etc.).

In block 406, the processor of the robot may execute the stored instruction set to perform various actions (e.g., moving, path-finding, scanning, etc.). For example, based on executing the various commands, operations, routines, and other data of the instruction set, the robot may travel to a location (e.g., to specified geographic coordinates) indicated in the stored instruction set. Actions that robots may perform based on the instruction set may be based on the type or class of the robots, the equipment or functionalities utilized by the robots (e.g., locomotion elements, sensors, etc.). In other words, when executed, the instruction set may cause the robot to perform various activities in accordance with its capabilities. In some embodiments, the instruction set may include various constraints for performing actions, such as timelines/deadlines for performing operations, geofence data (e.g., GPS coordinates of deployment sites, etc.), speeds for performing actions, and other limitations or guidelines for acting.

In block 408, the processor of the robot may generate an instruction set update in response to executing the stored instruction set. Such an update may be useful for the robot or other robots that share a similar objective or instruction set. For example, the generated update may include new instructions or data that may help other robots improve their efficiency when performing actions defined by similar instruction sets (or programming) Updates may include different values or orderings of information within the stored instruction sets, such as different values for variables and/or different orders for lists of command codes that may be executed by the robot. Further, the update may include deletions of information from the instruction set, such as the deletion of already performed operations, instructions, and/or routines. For example, in response to performing a movement operation, the robot may be configured to remove that movement operation from the instruction set as it is no longer needed to be performed. In some embodiments, instructions in the instruction set may be cyclic or repeatable and thus may not be deleted from the instruction set upon performance. In some embodiments, the instruction set update may be similar to the instruction set itself, but may utilize a different order or values for the same commands or instructions.

Such presentations of the generated instruction set update may include various data that may be used to indicate the source of the broadcasts (e.g., the identity or ‘device ID’ of the robot, GPS coordinates of the robot, the owner of the robot, etc.), authentication information (e.g., passwords, hashes, codes, etc.), the context or relevance of the broadcast (e.g., codes of the types, brands/makes of other robots that may use the instruction set update, etc.), and/or other information indicating the timestamp (e.g., freshness) and/or validity of the instruction set update.

In block 410, the processor of the robot may modify the stored instruction set with the generated instruction set update. For example, based on the performed actions and generated instruction set update, the robot may remove, change, and/or add instructions for performing subsequent actions.

In block 412, the processor of the robot may present the public generated instruction set update to device(s) (e.g., beacon devices) within proximity, such as by wirelessly transmitting (e.g., periodically broadcasting) or rendering data that represents the generated instruction set update. Various manners of presentation may be used. For example, the robot may broadcast messages or render a QR code that indicates instruction set updates that may or may not include other information, such as timestamps and/or authentication data (e.g., a hash, etc.). In optional block 413, the processor of the robot may receive a new instruction set from a beacon device within proximity. For example, the robot may receive Bluetooth broadcast messages and/or scan for presentations of data from nearby beacon devices. Various manners of receiving instruction sets are described below.

In optional determination block 414, the processor of the robot may determine whether the received new instruction set is valid for updating (e.g., changing, replacing, etc.) the stored instruction set. In other words, the robot may process any received, incoming messages to determine whether they include codes, text, symbols, and/or other data that are associated with its currently stored instruction set. For example, the robot may perform operations to parse and evaluate data packets received via a Bluetooth connection to identify whether the packets include executable code related to the currently stored instruction set on the robot. Valid instruction sets may be instruction sets or portions of instruction sets that are capable of being executed (e.g., error-free) by the robot as part of or in replacement of its current instruction set. Valid instruction sets may include codes or other identifying information that indicate the instruction sets are related to the type, class, or brand of the robot.

In some embodiments, in order to determine whether a received instruction set is valid, the robot may evaluate authentication data received with received instruction set to determine whether the instruction set is authenticated. For example, the robot may identify a sender device identifier within a received instruction set and compare that device identifier to a list of known or approved devices in order to determine whether the received instruction set can be trusted and thus installed and/or executed by the robot. As another example, the robot may evaluate a received message to determine whether a secret word or password is included that authenticates the included instruction set.

As described above, in some embodiments messages received from nearby beacon devices may include a hash or other data that may be compared to data stored on or calculated by the robot to confirm the identity of the sending device and/or the contents of the received instruction set communications. For example, when the robot and a beacon device are configured to utilize the same secret function (or secret configuration of a hash function), a hash value generated on the beacon device—or a robot sending updated instructions to the beacon device—using the secret function may be shared for comparison with data generated on the robot using the same secret function such that matching data may confirm the validity of the message with the instruction set. FIGS. 2A-2B show examples of authentication data presented via broadcast messages or a QR code (e.g., a random number or hash that may be used by the robot to confirm authenticity).

In some embodiments, the robot may determine that a received instruction set is valid in response to successfully compiling the instruction set in combination with or separate from its currently stored instruction set. For example, when the received instruction set cannot be merged into the currently stored instruction set to create a functional, executable set of instructions for the robot to perform, the instruction set may not be valid. As another example, instruction sets may be determined invalid when they include corrupted data, syntax issues, and/or other functional flaws.

In some embodiments, the robot may determine that a received instruction set is valid based on timestamp data. For example, when an instruction set (e.g., a set of commands, codes, or other data) has a timestamp older than the current timestamp of the current instruction set stored on the robot, the robot may determine the instruction set is invalid.

In response to determining that the received new instruction set is invalid (i.e., optional determination block 414=“No”), the robot may continue executing the stored instruction set in block 406 to perform various actions. In some embodiments, the robot may delete or otherwise ignore the received new instruction set.

In response to determining that the received new instruction set is valid (i.e., determination block 414=“Yes”), the processor of the robot may modify the stored instruction set based on the received, valid instruction set in optional block 416. For example, the robot may merge, append, and/or replace segments or the entirety of the previous instruction set with the received instruction set. The robot may also update a timestamp of the stored instruction set to represent that the instruction set has been modified, such as by change a date or time indicator associated with the stored instruction set to indicate a timestamp included within the received instruction set. In some embodiments, such timestamps may be stored on a per-segment basis to indicate different dates of different segments of the entirety of the stored instruction set. For example, individual methods, code blocks, and/or variables of the stored instruction set may be associated with timestamps that may be compared with subsequently received instruction sets to determine further valid updates. The robot may then execute the stored instruction set to perform various actions in block 406.

FIG. 4B illustrates an embodiment method 420 for a robot to provide instruction set updates to and/or receive new instruction sets from beacon devices within proximity. The method 420 is similar to the method 400 described with reference to FIG. 4A, except that the robot is explicitly described as being configured to present data and receiving data (e.g., transmit instruction set updates to beacon devices, receive new instruction sets from beacon devices) via short-range broadcast wireless signals, such as via connectionless Bluetooth advertisement packets.

The operations in blocks 402-410 may be similar to those described above for like numbered blocks. In block 422, the processor of the robot may broadcast the generated instruction set update via wireless signaling, such as by periodically broadcasting, via a short-range wireless transceiver and antenna, messages indicating the instructions of the public instruction set via Bluetooth, RF, Wi-Fi Direct, or other wireless communication protocols or standards. For example, the broadcast may be a packet (or packet stream) that includes codes or other data that may be received and recognized by beacon devices within proximity to indicate corrections, deletions, and/or additions to public instruction sets. The operations in block 422 may be similar to those described above with reference to block 412 in FIG. 4A.

In block 424, the processor of the robot may monitor for incoming messages from devices within proximity. The robot may be configured to continually evaluate an incoming message buffer to identify any received wireless communications. For example, the robot may monitor a buffer to determine whether a connectionless Bluetooth advertisement packet or pairing communication has been received from a beacon device. In some embodiments, the robot may be configured to utilize various sensors to monitor for signaling from devices within proximity, such as beacon devices. For example, the robot may periodically activate a camera, microphone, heat sensor, and/or light sensor to detect signaling from nearby beacon devices.

Based on the monitoring operations, the processor of the robot may determine whether a received new instruction set that is valid for updating the stored instruction set is received from a beacon device within proximity in determination block 426. In other words, the robot may process any received, incoming messages to determine whether they include codes, text, symbols, and/or other data that are associated with its currently stored instruction set. The operations in optional determination block 426 may be similar to those of optional determination block 414 described above with reference to FIG. 4A. In response to determining that a valid, new instruction set is not received (i.e., optional determination block 426=“No”), the robot may continue executing the stored instructions set to perform various actions in block 406 for. In response to determining that a new, valid instruction set is received (i.e., optional determination block 426=“Yes”), the processor of the robot may modify (e.g., change, replace, update, etc.) the stored instruction set based on the received, valid instruction set in optional block 416, and execute the modified instruction set in block 406.

FIG. 4C illustrates another embodiment method 450 for a robot to provide instruction set updates to beacon devices within proximity. The method 450 is similar to the method 400 described with reference to FIG. 4A, except that the robot is configured to establish wireless connections for exchanging data with beacon devices, such as via a Bluetooth connection established via a pairing process. Such established connections may enable sharing of instruction set information on an on-demand or one-to-one basis between a beacon device and a robot. In some embodiments, this may be beneficial in improving security of providing instruction set information, as only after a trusted connection is established may data be transmitted between devices.

The processor of the robot may perform the operations of blocks 402-410 as described above with reference to FIG. 4A for like numbered blocks. In block 452, the processor of the robot may establish a short-range wireless connection with a proximate beacon, such as Bluetooth connection between paired devices. In block 454, the processor of the robot may transmit the generated instruction set update (i.e., update generated in block 408) via the established connection. For example, the robot may transmit new instructions, commands to delete instructions from a public instruction set, and other data that may be used to adjust the public instruction set being distributed by the beacon device.

In optional block 456, the processor of the robot may receive, via the established connection, a new instruction set (i.e., a public instruction set from the beacon device). In some embodiments, the instruction set update may only be transmitted to the beacon device via the connection established in block 454 in response to the robot evaluating the new received instruction set from the beacon device and determining that the generated instruction update is more up-to-date than the new received instruction set.

As described above, in optional determination block 414, the processor of the robot may determine whether the new instruction set received from the proximate beacon is valid for updating the stored instruction set. For example, the robot may evaluate the received new instruction set to determine whether it is newer or more up-to-date than the current stored instruction set, applicable to the robot (e.g., for the same model/class/brand, etc.), and executable (e.g., does the instruction set compile, are there syntax errors, etc.). In response to determining that the new received instruction set is valid (i.e., optional determination block 414=“Yes”), the processor of the robot may modify the stored instruction set with the received new instruction set in optional block 416. In response to determining that the received instruction set from the proximate beacon is not valid (i.e., optional determination block 414=“No”), or in response to performing the operations in optional block 416, the processor of the robot may terminate the established connection with the beacon device within proximity in block 458, and continue executing the stored instruction set in block 406.

FIG. 4D illustrates another embodiment method 460 for a robot to provide instruction set updates to beacon devices within proximity. The method 460 is similar to the method 400 described with reference to FIG. 4A, except that the robot is explicitly described as being configured to scan displays of beacon devices. For example, using a light (infrared (IR)) sensor or camera, the robot may detect signals from a beacon device that indicate a new instruction set that may be implemented at the robot.

The processor of the robot may perform the operations of blocks 402-410 as described above with reference to FIG. 4A for like numbered blocks. In block 461, the processor of the robot may render the generated instruction set update, such as by displaying a QR code, a bar code, a pattern, and/or images on a screen (e.g., an LED screen), by playing a series of sounds, tweets, or noises via a speaker, by vibrating in certain patterns via a motor, and/or by emitting a series of flashing lights via a light source (e.g., a bulb), etc. For example, the robot may display on a screen a QR code representing the instruction set update. As another example, the robot may flash a bulb in a pattern to indicate the instruction set update in a manner similar to Morse code. In optional block 462, the processor of the robot may scan with sensors for presentations by a beacon device within proximity, such as by scanning for signaling via sounds, vibrations, etc. from a beacon device using a microphone, vibration sensors, etc. For example, the robot may use a camera to obtain imagery of an LED screen coupled to a device within proximity. In various embodiments, the robot may scan a display that is visible (or invisible) to the human eye, such as a light-emitting screen or bulb, audible, such as noises, clicks, beeps, or other sounds, and/or tangible, such as vibrations. Similarly, the display may be any number of units or devices coupled to the device within proximity that may be capable of producing signals that may be scanned, such as vibration motors, speakers, etc. Accordingly, the robot may perform the scanning with various devices or functionalities, such as microphones, cameras, and other sensors.

In optional block 464, the processor of the robot may identify an instruction set based on the scanning. For example, the robot may be configured to perform image processing routines that evaluate scanned imagery to identify symbols, patterns, and/or other information that the robot may identify as indicating instructions, code, and/or other data that may be used to adjust and/or replace its currently stored instruction set. In some embodiments, the robot may be configured to process and convert the scanned information into executable code.

In optional determination block 466, the processor of the robot may determine whether the identified instruction set from the beacon device within proximity is valid to modify (e.g., update, replace, etc.) the stored instruction set. The operations in optional determination block 466 are similar to those of optional determination block 414 described with reference to FIG. 4A, except that the robot may determine the validity (e.g., freshness based on a timestamp, error-free, etc.) of an instruction set obtained via scanning instead of received from wireless broadcasts. In response to determining that the identified instruction set is not valid for modifying the stored instruction set (i.e., optional determination block 466=“No”), the robot may continue executing the current instruction set to perform actions in block 406. In response to determining that the identified instruction set is valid (i.e., optional determination block 466=“Yes”), the processor of the robot may modify the stored current instruction set with the identified instruction set in optional block 468, such as by updating, adjusting, and/or replacing various segments or the entirety of the stored instruction set. The robot may then execute the modified instruction set to perform actions in block 406.

FIG. 4E illustrates another embodiment method 490 for a robot to provide instruction set updates to beacon devices within proximity. The method 490 is similar to the method 400 described with reference to FIG. 4A, except that the robot may also be configured to program and place new beacon devices that broadcast instruction sets having updated information. For example, the robot may program a beacon device stored in a rack coupled to the robot to broadcast a new instruction set based on the robot's latest activities using an original instruction set, and then may drop or throw the beacon device so that its broadcasts may be received by other robots that subsequently travel nearby.

The processor of the robot may perform the operations of blocks 402-410, 413, 414, 416 as described above with reference to FIG. 4A for like numbered blocks. In block 492, the processor of the robot may configure a new beacon to present (e.g., to broadcast, render, etc.) the stored instruction set. For example, the robot may wirelessly upload its currently stored instruction set so that it is stored and accessible by the new beacon device. Further, the robot may transmit signals that activate and prepare the new beacon device to begin broadcasting. For example, the robot may transmit a signal to the new beacon device that causes the beacon device to exit a sleep state, reboot, or simply turn on. In block 494, the processor of the robot may perform operations to cause the robot to place (or deploy) the new beacon device, such as by executing operations to cause a storage device to physically place (e.g., eject or drop) the new beacon device onto the ground within a deployment site.

In some embodiments, the robot may only configure and place a new beacon device in response to modifying the stored instruction set. For example, when the robot has not changed its instruction set due to its actions, no new beacon device may be programmed and placed. However, when an objective of the instruction set has been accomplished and thus the instruction set is modified, the robot may configure and deploy a new beacon device that broadcasts a new instruction set that does not include (or cause subsequent robots to perform) instructions for performing that already accomplished objective.

The processor of the robot may perform the operations of blocks 413-416 as described above with reference to FIG. 4A for like number, and may then perform the operations of block 406 as described above for performing various actions.

FIG. 4F illustrates another embodiment method 496 for a robot to provide instruction set updates to nearby beacon devices. The method 496 is similar to the method 400 described with reference to FIG. 4A, except that the method 460 may include operations for the robot to exchange data with a remote data source when a wide area network (WAN) connection is available. For example, when the robot is within an area having cellular network coverage, the robot may communicate with a cloud server, such as by transmitting access logs and/or receiving instruction sets or other software to be executed at the robot and/or relayed to nearby beacon devices.

The operations in blocks 402-416 may be similar to those described above for like numbered blocks. In determination block 497, the processor of the robot may determine whether a wide area network connectivity is available, such as by determining whether a signal strength of signals from cellular network base stations is above a predefined threshold and/or whether there are any predefined (e.g., authorized, authenticated, etc.) access points that may be connected to. In other words, the robot may periodically determine whether it has been moved into an area with WAN coverage or otherwise gained or recovered access to the Internet or other WAN. In some embodiments, the WAN connectivity may be determined based on whether the robot can connect to a local area network (LAN) that provides WAN access. In response to determining that there is no WAN connectivity available (i.e., determination block 467=“No”), the robot may continue with the operations in block 406 as described above.

In response to determining that there is WAN connectivity available (i.e., determination block 497=“Yes”), the processor of the robot may exchange data with a remote data source in block 498, such as a cloud server. For example, the robot may provide updated activity data (e.g., messages sent, messages received, timestamps, etc.) to a server via the Internet for storage. As another example, the robot may receive applications, instructions, and other data from the remote source that may be executed locally by the robot and/or provided to nearby beacon devices. In some embodiments, the robot may modify stored instruction sets based on the exchanged data with the data source. The robot may continue with the operations for executing the stored instruction set in block 406 as described above.

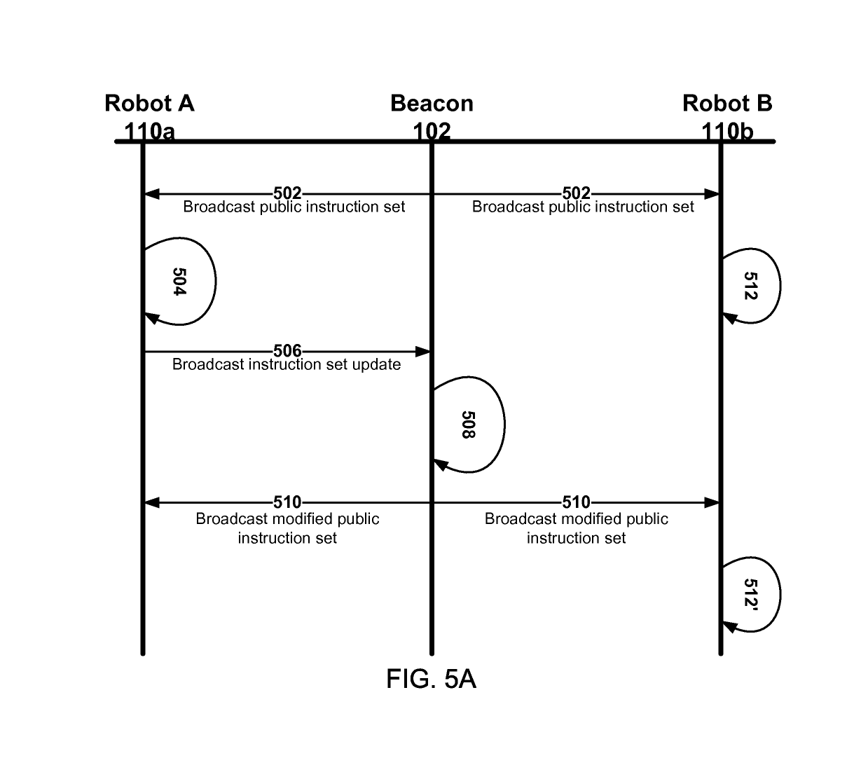

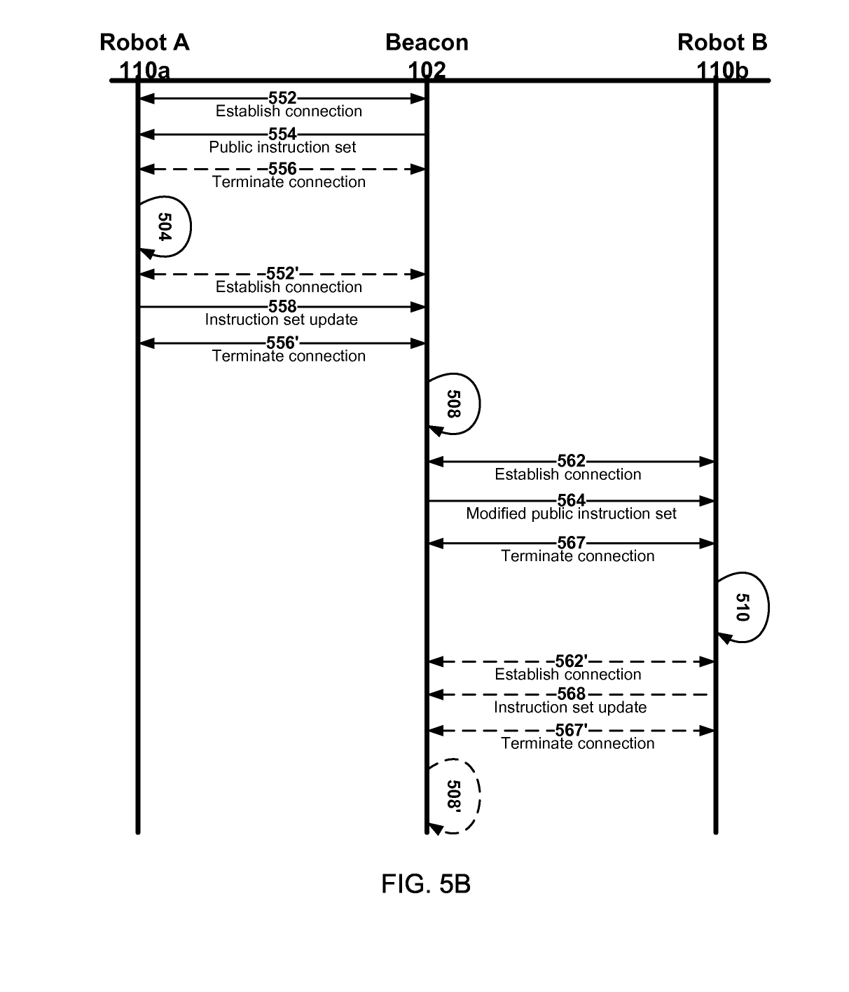

FIGS. 5A-5B illustrate various communications that may be accomplished between a beacon device 102 and robots 110a, 110b according to various embodiments.

Referring to FIG. 5A, a beacon device 102 may periodically broadcast messages 502, such as Bluetooth connectionless packets (or advertisements) that include a public instruction set. In response to receiving the broadcast messages 502, a first robot 110a (referred to in FIGS. 5A-5B as “Robot A”) may perform various operations 504 and a second robot 110b (referred to in FIGS. 5A-5B as “Robot B”) may perform various operations 512. For example, the first robot 110a may perform operations to update its currently stored instruction set as well as execute some or all of the instructions of its updated instruction set. For example, the first robot 110a may perform actions defined by a new set of instructions received from the beacon device 102 received via the broadcast messages 502, such as travel to and/or scan a particular section of a deployment site.

In response to performing the operations 504, the first robot 110a may generate and broadcast an instruction set update 506 that may be received and processed by the beacon device 102 with the operations 508. For example, the beacon device 102 may modify its public instruction set based on the information within the broadcast instruction set update 506 (e.g., indicators of completed tasks, data that adds to a collective data set, etc.). The beacon device 102 may then periodically broadcast messages 510 that include the modified public instruction set that may be received by the first robot 110a and the second robot 110b. In response to receiving such broadcasts, the second robot 110b may perform operations 512′ to modify or replace its currently stored instruction set based on the public instruction set included within the broadcast message 510. The first robot 110a may receive the broadcast message 510 but may not modify its already stored instruction set as the modified public instruction set indicated by the broadcast message 510 may be based on the first robot's instruction set update, and thus the first robot 110a may already have the most up-to-date instructions.

Referring to FIG. 5B, in some embodiments the robots 110a, 110b, and beacon device 102 may be configured to exchange data via connectionless signaling (e.g., Bluetooth broadcast messages) or via wireless connections, such as wireless connections between paired devices. Accordingly, the beacon device 102 and the first robot 110a may establish a wireless connection 552. In some embodiments, the wireless connection 552 may be established in response to the first robot 110a and beacon device 102 exchanging various handshaking or authentication signals/messages, and further may require a pre-established relationship between the devices 110a, 102, such as based on previous connections and/or pre-stored data identifying each other (e.g., a database of known, paired, and/or trusted devices).

Using the established wireless connection 552, the beacon device 102 may transmit a public instruction set transmission 554 to the first robot 110a that indicates an up-to-date public instruction set relevant to the first robot 110a. In some embodiments, the first robot 110a may transmit to the beacon device 102 data indicating the currently stored instruction set on the first robot 110a in order to receive the public instruction set transmission 554. For example, based on an initial disclosure message by the first robot 110a, such as a message that indicates its class, type, and/or currently stored instruction set, the beacon device 102 may identify the appropriate public instruction set for that robot and deliver it to the first robot 110a.

In response to receiving the public instruction set transmission 554, the first robot 110a may perform operations 504, such as operations to modify or otherwise update its stored instruction set, as well as perform actions by executing the updated, stored instruction set. In some embodiments, in response to receiving the public instruction set transmission 554, the first robot 110a and the beacon device 102 may terminate the connection 556, such as by ending a communication session to enable the first robot 110a to begin performing actions indicated by the public instruction set. In some embodiments, the established connection may be maintained (i.e., not terminated) as the first robot 110a executes the instructions from the public instruction set transmission 554.

In response to receiving the public instruction set transmission 554, the first robot 110a may perform operations 504, such as modifying a currently stored instruction set, performing actions defined by the instruction set (e.g., scanning, traveling, etc.), and/or generating an instruction set update based on performing various actions. In some embodiments, when the established wireless connection 552 was terminated prior to the first robot 110a performing the operations 504, the first robot 110a and the beacon device 102 may again establish the wireless connection 552′ in order to exchange data. The first robot 110a may transmit an instruction set update transmission 558 that indicates modifications or updates to the public instruction set stored on the beacon device 102, and the devices 110a, 102 may terminate the connection 556′. In response to receiving the instruction set update transmission 558, the beacon device 102 may perform operations 508 to utilize the received instruction set update transmission 558, such as by modifying its stored public instruction set (e.g., adding commands, removing commands, etc.).

Subsequently, the beacon device 102 and a second robot 110b may establish another wireless connection 562 between the first robot 110a and the beacon device 102. Using the established wireless connection 562, the beacon device 102 may transmit a modified public instruction set transmission 564 that includes the public instruction set that has been modified based on the update from the first robot 110a. The beacon device 102 and the second robot 110b may then terminate the wireless connection 567.

In response to receiving the modified public instruction set transmission 564, the second robot 110b may perform operations, such as by updating its stored instruction set based on the modified public instruction set transmission 564, and performing actions (e.g., scanning, traveling, etc.). In some embodiments, the beacon device 102 and the second robot 110b may establish another wireless connection 562′ and the second robot 110b may transmit an instruction set update transmission 568 to the beacon device 102, and then terminate the connection 567′. In response, the beacon device 102 may perform operations 508′ to update the public instruction set based on the instruction set update transmission 568 received from the second robot 110b.

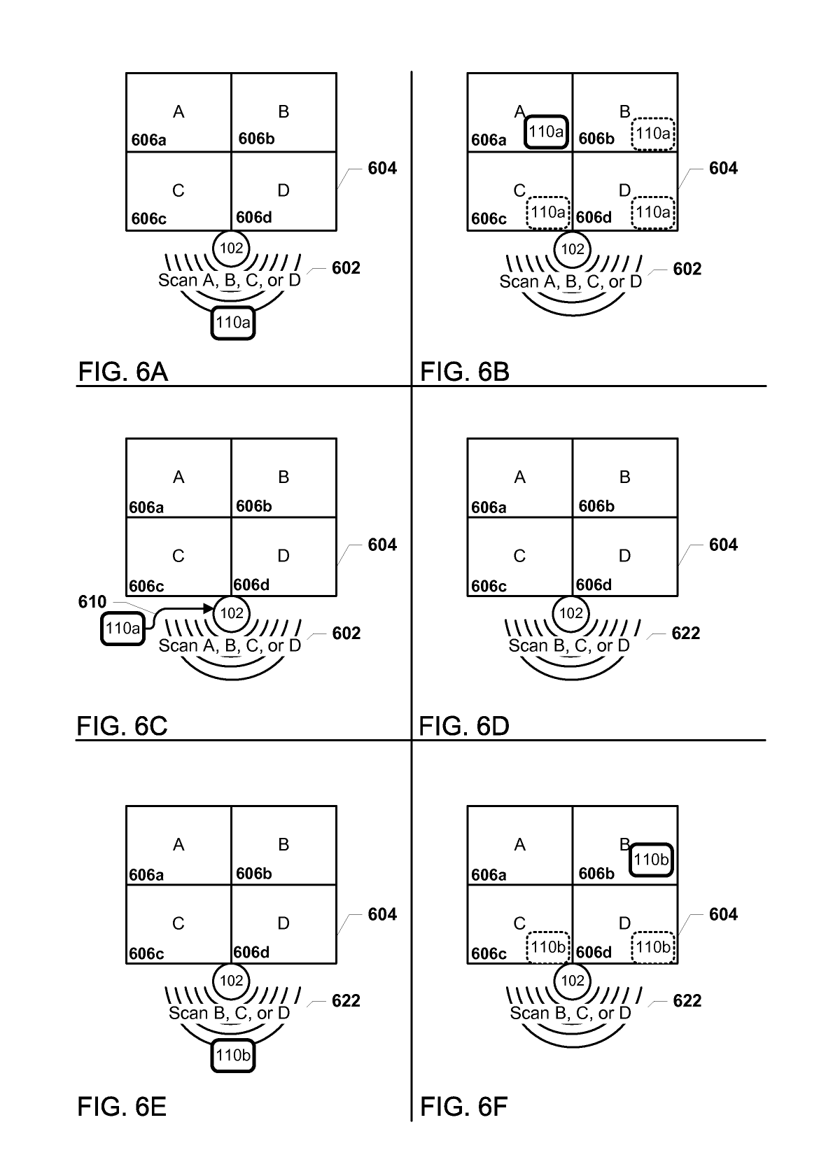

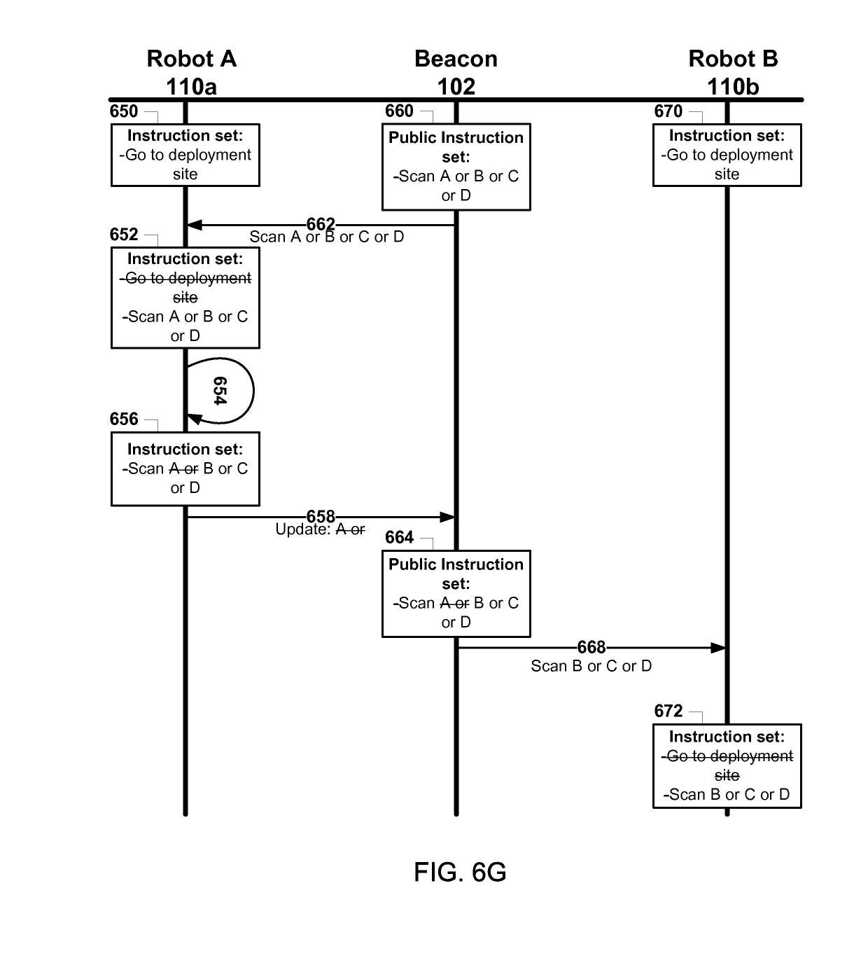

FIGS. 6A-6F illustrate an exemplary scenario that involves a beacon device 102 and various robots 110a, 110b near a deployment site 604 (e.g., a forest to be mapped by scanning operations conducted by the robots 110a, 110b. The deployment site 604 may include a plurality of sections 606a-606d, such as rooms or floors of a building or grids of a parcel of land, etc. Further, the beacon device 102 may be configured to periodically broadcast messages that include a public instruction set that is stored on the beacon device 102 and related to actions that may be performed by the robots 110a, 110b in the deployment site 604. In various embodiments, the robots 110a, 110b of FIGS. 6A-6F may be similar to the robots described with reference to FIGS. 1, 4A-4F, and 5A-5B. In various embodiments, the beacon device 102 of FIGS. 6A-5F may be similar to the beacon devices described with reference to FIGS. 1, 2A-3E, and 5A-5B.

The first robot 110a may move within proximity of the beacon device 102 positioned outside of (or on the perimeter of) the deployment site 604. For example, the first robot 110a may have traveled (e.g., rolled, flown, etc.) to the deployment site 604 based on an initial instruction set or program the first robot 110a stored based on programming from a manufacturer, a technician, or other operator. The beacon device 102 may broadcast a first public instruction set 602. For example, the first public instruction set 602 may include a set of commands that indicate robots receiving the broadcast should scan any of the plurality of sections 606a-606d (e.g., sections A, B, C, or D) of the deployment site 604. When near the beacon device 102 (i.e., within broadcast range of the beacon device 102), the first robot 110a may receive the broadcast of the first public instruction set 602. In response, the first robot 110a may modify (e.g., replace or update) its currently stored instruction set to include the instructions from the received broadcasts from the beacon device 102. In other words, in response to receiving the broadcast of the first public instruction set 602, the first robot 110a may modify its instruction set (or programming) to direct the first robot 110a to scan any of the sections 606a-606d of the deployment site 604.

FIG. 6B illustrates the first robot 110a within the first section 606a (section A) of the deployment site 604, performing actions of its stored instruction set modified based on the first public instruction set 602. For example, the first robot 110a may use a camera to scan the landscape, objects, and/or other characteristics within the first section 606a. Although the first robot 110a is shown within the first section 606a, the first robot 110a may have optionally gone to perform actions within any of the other sections 606b-606d based on the first public instruction set 602.

FIG. 6C illustrates the first robot 110a returning to the beacon device 102 upon completion of its operations within the first section 606a. The first robot 110a may transmit an instruction set update transmission 610 (e.g., a Bluetooth broadcast message, etc.) indicating the actions performed by the first robot 110a within the first section 606a. The beacon device 102 may process the instruction set update transmission 610 and modify the public instruction set stored on the beacon device 102. In particular, and as shown in FIG. 6D, the beacon device 102 may modify the public instruction set to no longer indicate that the first section 606a of the deployment site 604 needs to be scanned. Thus, the beacon device 102 may begin broadcasting a second public instruction set 622 that indicates that all but the first section 606a may be scanned by subsequent robots (i.e., sections B-D still need to be scanned).

FIG. 6E illustrates the second robot 110b moving near the beacon device 102 (i.e., within broadcast range), and thus able to receive the broadcast of the second public instruction set 622. In response, the second robot 110b may modify (e.g., replace or update) its currently stored instruction set to include the instructions from the received broadcast of the second public instruction set 622 from the beacon device 102. In other words, in response to receiving the broadcast of the second public instruction set 622, the second robot 110b may modify its instruction set (or programming) to direct the second robot 110b to scan any of the sections 606b-606d of the deployment site 604.

FIG. 6F illustrates the second robot 110b within the second section 606b (section B) of the deployment site 604, performing actions of its stored instruction set modified based on the second public instruction set 622. For example, the second robot 110b may use a camera to scan the landscape, objects, and/or other characteristics within the second section 606b. Although the second robot 110b is shown within the second section 606b, the second robot 110b may have optionally gone to perform actions within any of the other sections 606c-606d based on the second public instruction set 622.

FIG. 6G illustrates embodiment modifications of instruction sets of robots 110a, 110b and a beacon device 102 according to the exemplary scenario shown in FIGS. 6A-6F. In various embodiments, the robots 110a, 110b of FIG. 6G may be similar to the robots described with reference to FIGS. 1, 4A-4F, 5A-5B, and 6A-6F. In various embodiments, the beacon device 102 of FIG. 6G may be similar to the beacon devices described with reference to FIGS. 1, 2A-3E, 5A-5B, and 6A-6F.

With reference to FIG. 6G and FIGS. 1-6F, the first robot 110a (referred to in FIG. 6G as “Robot A”) may be configured to utilize an initial instruction set 650 that includes instructions causing the first robot 110a to go to a deployment site. Similarly, the second robot 110b (referred to in FIG. 6G as “Robot B”) may be configured to utilize an initial instruction set 670 that also includes instructions causing the second robot 110b to go to the deployment site. The beacon device 102 may store a public instruction set 660 that includes instructions for robots to scan any of a plurality of sections of the deployment site (e.g., sections A, B, C, or D). The beacon device 102 may periodically broadcast the public instruction set 660 via a broadcast message 662. When within broadcast range of the beacon device 102, the first robot 110a may receive the broadcast message 662, and in response, may modify (or replace) its stored initial instruction set 650 to generate and store a modified instruction set 652. In particular, already being at the deployment site, the modified instruction set 652 may no longer include operations for the first robot 110a to go to the deployment site, but instead may now include instructions for scanning any of the sections of the deployment site (e.g., A, B, C, or D).

The first robot 110a may perform operations 654 based on the modified instruction set 652, such as moving to and scanning a first section (e.g., section A) in the deployment site. In response to performing the operations 654, the first robot 110a may generate an update to the stored modified instruction set 652 and may store a new instruction set 656 indicating the operations 654 that have been performed. In other words, the first robot 110a may generate an instruction set update that changes the list of instructions that need to be (or can be) performed by the first robot 110a. The first robot 110a may transmit the generated update as an instruction set update transmission 658, such as an update that indicates that the first section of the deployment site no longer needs to be scanned due to the operations 654 having already been performed. For example, the instruction set update transmission 658 may include a code or command that may cause the beacon device 102 to remove section A from the list of sections that need to be scanned in the deployment site. In response to receiving the instruction set update transmission 658, the beacon device 102 may stored a modified version 664 of the public instruction set 660 that is based on the instruction set update generated and transmitted by the first robot 110a. For example, the modified public instruction set 664 may no longer indicate that the first section (e.g., Section A) needs to be scanned).

Subsequently, the second robot 110b may move within broadcast range of the beacon device 102 that is broadcasting the modified public instruction set 664 via a broadcast message 668. Upon receiving the broadcast message 668, the second robot 110b may modify its stored initial instruction set 670 based on the modified public instruction set 664 within the broadcast message 668. In other words, the second robot 110b may generate a second instruction set 672 that includes instructions for the second robot 110b to only scan sections of the deployment site that have not already been scanned (e.g., scan only sections B, C, or D).

Various embodiments may be implemented in any of a variety of beacon devices, an example of which (e.g., beacon device 700) is illustrated in FIG. 7. According to various embodiments, the beacon device 700 may be similar to the beacon devices described with reference to FIGS. 1-3E, 5A-6G. As such, the beacon device 700 may be capable of implementing the methods 300, 320, 350, 380, and 390 in FIGS. 3A-3E.

The beacon device 700 may include a processor 701 coupled to an internal memory 702, a short-range transceiver 704 coupled to an antenna 705 capable of exchanging energy (e.g., electromagnetic energy), and a power source 712. The processor 701 may be one or more multi-core integrated circuits designated for general or specific processing tasks. In some embodiments, the processor 701 may be a Bluetooth system-on-chip unit. The internal memory 702 may be volatile or non-volatile memory, and may also be secure and/or encrypted memory, or unsecure and/or unencrypted memory, or any combination thereof. The memory 702 may be used by the beacon device 700 to store software, algorithms, instructions, instruction sets, code, or other routines. In some embodiments, the memory 702 may be contained within the processor 701, which may also include a separate processing unit.

The short-range transceiver 704 may be capable of handling communications via various wireless standards and/or protocols, such as Bluetooth, Zigbee, Wi-Fi, RF, WiFi-Direct, etc. As described above, the beacon device 700 may utilize the short-range transceiver 704 and antenna 705 to transmit (e.g., broadcast, via established connection, etc.) messages indicating instruction sets that may be utilized by robots and/or to receive updates from robots that may be used by the beacon device 700 to update public instruction sets. In some embodiments, the beacon device 700 may be configured to transmit signals via the short-range transceiver 704 and antenna 705 at varying signal strengths, thereby varying the range at which broadcasts from the beacon device 700 may be received by devices within proximity. In some embodiments, the antenna 705 may include one or more antenna.

In some embodiments, the processor 701, the short-range transceiver 704, and/or the memory 702 may be integrated together as a single integrated circuit. Since these components may be microchips of standard or off-the-shelf configuration, they are represented in FIG. 7 as blocks consistent with the structure of an example embodiment.

The power source 712 may be a battery, such as a replaceable coin cell battery, or alternatively may be an interface connected to an external power (e.g., a wall outlet, an external battery/power supply, etc.) source via a connection 713 (e.g., a wire, power cord, etc.).

In some embodiments, the beacon device 700 may also include various input units 715 coupled to the processor 701, such as buttons, keypads, sliders, dials, keyboards, and/or other input devices capable of receiving user inputs. For example, the input units 715 may be peripherals (e.g., a keyboard, a mouse, etc.) that may be used by a user to program or otherwise enter an initial instruction set for storage and broadcast by the beacon device 700.

In some embodiments, the processor 701 may also be coupled to a long-range transceiver 706 (or network interface or networking device) capable of exchanging communications via a wide area network (WAN), such as a cellular network. In some embodiments, the long-range transceiver 706 may include or be coupled to a cellular modem. In some embodiments, the long-range transceiver 706 may be coupled to the antenna 705 or a separate antenna (not shown). In some embodiments, the beacon device 700 may further include a GPS receiver (not shown) coupled to the processor 701.

In some embodiments, the processor 701 may also be coupled to a rendering unit(s) 708 capable of rendering information, such as speakers, lights-emitting units (e.g., light bulbs, etc.), a vibration motor, and/or a display screen (e.g., an LED or LCD screen, a resistive-sensing touch screen, capacitive-sensing touch screen, infrared sensing touch screen, etc. Such displays of the beacon device 700 may or may not have touch screen capability. For example, the beacon device 700 may be configured to emit sounds via a speaker capable of being received by a nearby device (e.g., a robot) and/or heard by a user.

In some embodiments, the beacon device 700 may include one or more sensors 710 for measuring various conditions and/or receiving communications from devices within proximity (e.g., a robot configured to communicate via light signals, sounds, vibrations, etc.). For example, sensors that may be included within the beacon device 700 include a camera, a microphone, infrared sensors or any combination of these and other sensors. These example sensors 710 are only examples of the types of sensors that may be integrated into the beacon device 700. For example, the beacon device 700 may also include sensors not shown in the various diagrams, such as a heat sensor, a pressure sensor, a motion sensor, and a light sensor.

The various components of the beacon device 700 may be linked or otherwise connected via a bus 714 or similar circuitry, and further may be interconnected and configured in various ways.

Various embodiments may be implemented in any of a variety of robots, an example of which (e.g., robot 800) is illustrated in FIG. 8. According to various embodiments, the robot 800 may be similar to the robots described with reference to FIGS. 1, 4A-4F, 5A-5B, and 6A-6G. As such, the robot 800 may be capable of implementing the methods 400, 420, 450, 460, 490, and 496 in FIGS. 4A-4F.

The robot 800 may include a processor 801 coupled to an internal memory 802, a short-range transceiver 804 coupled to an antenna 805 capable of exchanging energy (e.g., electromagnetic energy), and a power source 812. The processor 801 may be one or more multi-core integrated circuits designated for general or specific processing tasks. The internal memory 802 may be volatile or non-volatile memory, and may also be secure and/or encrypted memory, or unsecure and/or unencrypted memory, or any combination thereof. The memory 802 may be used by the robot 800 to store software, algorithms, instructions, instruction sets, code, or other routines. In some embodiments, the memory 802 may be contained within the processor 801, which may also include a separate processing unit.

The short-range transceiver 804 may be capable of handling communications via various wireless standards and/or protocols, such as Bluetooth, Zigbee, Wi-Fi, RF, WiFi-Direct, etc. As described above, the robot 800 may utilize the short-range transceiver 804 and antenna 805 to exchange (e.g., broadcast, via established connection, etc.) messages that may be utilized by various devices within proximity, such as other robots and/or beacon devices. In some embodiments, the antenna 805 may include one or more antenna.

In some embodiments, the processor 801, the short-range transceiver 804, and/or the memory 802 may be integrated together as a single integrated circuit. Since these components may be microchips of standard or off-the-shelf configuration, they are represented in FIG. 8 as blocks consistent with the structure of an example embodiment. The power source 812 may be a battery, such as a replaceable or rechargeable battery.

In some embodiments, the processor 801 may also be coupled to a long-range transceiver 806 (or network interface or networking device) capable of exchanging communications via a wide area network (WAN), such as a cellular network. In some embodiments, the long-range transceiver 806 may include or be coupled to a cellular modem. In some embodiments, the long-range transceiver 806 may be coupled to the antenna 805 or a separate antenna (not shown). In some embodiments, the robot 800 may further include a GPS receiver (not shown) coupled to the processor 801.

In some embodiments, the processor 801 may also be coupled to a rendering unit(s) 808 capable of rendering information, such as speakers, lights-emitting units (e.g., light bulbs, etc.), and/or a display screen (e.g., an LED or LCD screen, a resistive-sensing touch screen, capacitive-sensing touch screen, infrared sensing touch screen, etc. Such displays of the robot 800 may or may not have touch screen capability. For example, the robot 800 may be configured to emit sounds via a speaker capable of being received by a nearby device (e.g., a robot, a beacon device, etc.) and/or heard by a user.

In some embodiments, the robot 800 may include one or more sensors 810 for measuring various conditions and/or receiving communications from devices within proximity (e.g., a beacon device configured to communicate via light signals, sounds, vibrations, etc.). For example, sensors that may be included within the robot 800 include a camera, a microphone, infrared sensors or any combination of these and other sensors. These example sensors 810 are only examples of the types of sensors that may be integrated into robots. For example, the robot 800 may also include sensors not shown in the various diagrams, such as a heat sensor, a pressure sensor, a motion sensor, and a light sensor.

In some embodiments, the robot 800 may also include various input units 815 coupled to the processor 801, such as buttons, keypads, sliders, dials, keyboards, and/or other input devices capable of receiving user inputs. For example, the input units 815 may be peripherals (e.g., a keyboard, a mouse, etc.) that may be used by a user to program or otherwise enter an initial instruction set that may be stored in the memory 802 and executed by the processor 801.

In some embodiments, the robot 800 may be configured to store and/or distribute beacon devices as described herein. In such embodiments, the robot 800 may include a beacon programming and placement control component 816 coupled to the processor 801 as well as a beacon storage unit 817. The beacon programming and placement control component 816 may be a module, device, or other unit capable of interfacing with and programming the various beacon devices stored within the beacon storage unit 817. The beacon storage unit 817 may be a holder, rack, or other device configured to hold one or more beacon devices that may be programmed and placed by the robot 800. The beacon storage unit 817 may include various devices for removing, ejecting, or otherwise moving beacon devices off or out of the robot 800 (i.e., to place the beacon devices).

Programming performed by the beacon programming and placement control component 816 may be transmitted via wireless or wired connections to beacon devices stored within the beacon storage unit 817. For example, the beacon programming and placement control component 816 may include wires, plugs, and/or signaling units for providing instruction sets to the beacon devices held within the beacon storage unit 817. Via the beacon programming and placement control component 816, the robot 800 may be capable of programming beacon devices prior to placing such devices, such as by dropping or laying beacon devices on a floor of a deployment site (e.g., within a building, in an outdoor space, etc.). The various components of the robot 800 may be linked or otherwise connected via a bus 814 or similar circuitry, and further may be interconnected and configured in various ways.

The various processors described herein may be any programmable microprocessor, microcomputer or multiple processor chip or chips that can be configured by software instructions (applications) to perform a variety of functions, including the functions of the various embodiments described herein. In the various devices, multiple processors may be provided, such as one processor dedicated to wireless communication functions and one processor dedicated to running other applications. Typically, software applications may be stored in internal memory before they are accessed and loaded into the processors. The processors may include internal memory sufficient to store the application software instructions. In many devices the internal memory may be a volatile or nonvolatile memory, such as flash memory, or a mixture of both. For the purposes of this description, a general reference to memory refers to memory accessible by the processors including internal memory or removable memory plugged into the various devices and memory within the processors.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a non-transitory processor-readable, computer-readable, or server-readable medium or a non-transitory processor-readable storage medium. The steps of a method or algorithm disclosed herein may be embodied in a processor-executable software module or processor-executable software instructions which may reside on a non-transitory computer-readable storage medium, a non-transitory server-readable storage medium, and/or a non-transitory processor-readable storage medium. In various embodiments, such instructions may be stored processor-executable instructions or stored processor-executable software instructions. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory processor-readable storage medium and/or computer-readable medium, which may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method for communicating instruction sets to robots, comprising:
presenting, by a processor of a beacon device, a stored instruction set to a first robot;
receiving, by the processor of the beacon device, an instruction set update from the first robot;
modifying, by the processor of the beacon device, the stored instruction set based on the received instruction set update to generate a modified instruction set; and
presenting, by the processor of the beacon device, the modified instruction set to a second robot.

2. The method of claim 1, further comprising determining, by the processor of the beacon device, whether the instruction set update is valid, and
wherein modifying, by the processor of the beacon device, the stored instruction set based on the received instruction set update comprises modifying the stored instruction set in response to determining that the instruction set update is valid.

3. The method of claim 2, wherein determining, by the processor of the beacon device, whether the instruction set update is valid comprises determining whether the instruction set update is capable of being executed by the robots, is authenticated, is related to a type of robot, can be compiled with regards to the stored instruction set, and is newer than a portion of the stored instruction set.

4. The method of claim 1, wherein modifying, by the processor of the beacon device, the stored instruction set based on the received instruction set update comprises replacing the stored instruction set or a portion of the stored instruction set with the received instruction set update.

5. The method of claim 1, wherein presenting, by the processor of the beacon device, the stored instruction set or the modified instruction set comprises at least one of:
broadcasting data via wireless signaling;
transmitting the data via an established wireless connection; and
rendering the data on one of a display, a speaker, a light source, and a vibration motor.

6. The method of claim 1, wherein presenting the stored instruction set or the modified instruction set comprises rendering the stored instruction set or the modified instruction set as a quick response (QR) code on a display.

7. The method of claim 1, wherein receiving, by the processor of the beacon device, the instruction set update from the first robot comprises at least one of:
receiving the instruction set update via wireless broadcasts from the first robot;
receiving the instruction set update via an established wireless connection with the first robot; and
receiving the instruction set update from the first robot using a sensor selected from a group of a camera, a microphone, a light sensor, and a vibration sensor.

8. The method of claim 1, wherein the stored instruction set is one of a plurality of instruction sets stored on the beacon device, wherein each in the plurality of instruction sets stored on the beacon device corresponds to a different type of robot.

9. The method of claim 1, further comprising:
determining, by the processor of the beacon device, whether wide area network connectivity is available; and
exchanging, by the processor of the beacon device, data with a remote data source in response to determining that wide area network connectivity is available.

10. A method for a robot to update instruction sets that are presented by a beacon device for use by other robots within proximity, comprising:
executing, by a processor of the robot, a stored instruction set to cause the robot to perform actions;
generating, by the processor of the robot, an instruction set update in response to performing the actions based on an execution of the stored instruction set; and
presenting, by the processor of the robot, the instruction set update to the beacon device.

11. The method of claim 10, further comprising:
receiving, by the processor of the robot, a new instruction set from the beacon device;
modifying, by the processor of the robot, the stored instruction set based on the received new instruction set to generate a modified instruction set; and
executing, by the processor of the robot, the modified instruction set.

12. The method of claim 11, further comprising determining, by the processor of the robot, whether the new instruction set is valid, and
wherein modifying, by the processor of the robot, the stored instruction set based on the received new instruction set comprises modifying the stored instruction set in response to determining that the new instruction set is valid.

13. The method of claim 12, wherein determining, by the processor of the robot, whether the new instruction set is valid comprises determining one or more of whether the new instruction set is capable of being executed by the robot, is authenticated, is related to a type of robot corresponding to the robot, can be compiled with regards to the stored instruction set, and is newer than a portion of the stored instruction set.

14. The method of claim 11, wherein modifying, by the processor of the beacon device, the stored instruction set based on the received new instruction set comprises replacing, by the processor of the robot, the stored instruction set or a portion of the stored instruction set with the received new instruction set.

15. The method of claim 11, wherein receiving, by the processor of the robot, the new instruction set from the beacon device comprises at least one of:
receiving the new instruction set via wireless broadcasts from the beacon device;
receiving the new instruction set via an established wireless connection with the beacon device; and
receiving the new instruction set from the beacon device by scanning using a sensor selected from the group of a camera, a microphone, a light sensor, and a vibration sensor.

16. The method of claim 11, further comprising:
configuring a new beacon device to present the modified instruction set; and
deploying the new beacon device.

17. The method of claim 16, wherein deploying the new beacon device comprises placing the new beacon device into a deployment site.

18. The method of claim 10, wherein presenting, by the processor of the robot, the instruction set update to the beacon device comprises at least one of:
broadcasting the instruction set update via wireless signaling;
transmitting the instruction set update via an established wireless connection; and
rendering the instruction set update on one of a display, a speaker, a light source, and a vibration motor.

19. A beacon device, comprising:
a processor configured with processor-executable instructions for performing operations comprising:
presenting a stored instruction set to a first robot;
receiving an instruction set update from the first robot;
modifying the stored instruction set based on the received instruction set update to generate a modified instruction set; and
presenting the modified instruction set to a second robot.

20. The beacon device of claim 19, wherein the processor is configured with processor-executable instructions to perform operations further comprising determining whether the instruction set update is valid, and
wherein the processor is configured with processor-executable instructions to perform operations such that modifying the stored instruction set based on the received instruction set update comprises modifying the stored instruction set in response to determining that the instruction set update is valid.

21. The beacon device of claim 20, wherein the processor is configured with processor-executable instructions to perform operations such that determining whether the instruction set update is valid comprises determining whether the instruction set update is capable of being executed by robots, is authenticated, is related to a type of robot, can be compiled with regards to the stored instruction set, and is newer than a portion of the stored instruction set.

22. The beacon device of claim 19, wherein the processor is configured with processor-executable instructions to perform operations such that modifying the stored instruction set based on the received instruction set update comprises replacing the stored instruction set or a portion of the stored instruction set with the received instruction set update.

23. The beacon device of claim 19, wherein the processor is configured with processor-executable instructions to perform operations such that presenting the stored instruction set or the modified instruction set comprises at least one of:
broadcasting data via wireless signaling;
transmitting data via an established wireless connection; and
rendering data on one of a display, a speaker, a light source, and a vibration motor.

24. The beacon device of claim 19, wherein the processor is configured with processor-executable instructions to perform operations such that presenting the stored instruction set or the modified instruction set comprises rendering the stored instruction set or the modified instruction set as a quick response (QR) code on a display.

25. The beacon device of claim 19, wherein the processor is configured with processor-executable instructions to perform operations such that receiving the instruction set update from the first robot comprises at least one of:
receiving the instruction set update via wireless broadcasts from the first robot;
receiving the instruction set update via an established wireless connection with the first robot; and
receiving the instruction set update from the first robot using a sensor selected from a group of a camera, a microphone, a light sensor, and a vibration sensor.

26. A robot, comprising:
a processor configured with processor-executable instructions for performing operations comprising:
executing a stored instruction set to cause the robot to perform actions;
generating an instruction set update in response to performing the actions based on an execution of the stored instruction set; and
presenting the instruction set update to a beacon device.

27. The robot of claim 26, wherein the processor is configured with processor-executable instructions to perform operations further comprising:
receiving a new instruction set from the beacon device;
modifying the stored instruction set based on the received new instruction set to generate a modified instruction set; and
executing the modified instruction set.

28. The robot of claim 27, wherein the processor is configured with processor-executable instructions to perform operations further comprising determining whether the new instruction set is valid, and
wherein the processor is configured with processor-executable instructions to perform operations such that modifying the stored instruction set based on the received new instruction set comprises modifying the stored instruction set in response to determining that the new instruction set is valid.

29. The robot of claim 27, wherein the processor is configured with processor-executable instructions to perform operations such that receiving the new instruction set from the beacon device comprises at least one of:
receiving the new instruction set via wireless broadcasts from the beacon device;
receiving the new instruction set via an established wireless connection with the beacon device; and
receiving the new instruction set from the beacon device by scanning using a sensor selected from a group of a camera, a microphone, a light sensor, and a vibration sensor.

30. The robot of claim 27, wherein the processor is configured with processor-executable instructions to perform operations further comprising:
configuring a new beacon device to present the modified instruction set; and
deploying the new beacon device.
